(19) United States
(12) Patent Application Publication
(10) Pub. No.: US 2011/0282024 A1
(43) Pub. Date: Nov. 17, 2011

(54) CATALYSTS FOR THE CROSS-LINKING OF FUNCTIONAL SILANES OR FUNCTIONAL SILOXANES, PARTICULARLY WITH SUBSTRATES

(75) Inventors: Kerstin Weissenbach, Hillsborough, NJ (US); Jaroslaw Monkiewicz, Rheinfelden (DE); Burkhard Standke, Loerrach (DE); Manuel Friedel, Zürich (CH); Thomas Schlosser, Inzlingen (DE); Philipp Albert, Loerrach (DE)

(73) Assignee: Evonik Degussa GmbH, Essen (DE)

(21) Appl. No.: 13/062,225

(22) PCT Filed: Jul. 9, 2009
(86) PCT No.: PCT/EP2009/058723

§ 371 Date: May 16, 2011

(30) Foreign Application Priority Data
Sep. 9, 2008 (DE) 102008041920.6

(51) Int. Cl. C08G 71/04; C07F 7/02; C07F 7/18

(52) U.S. Cl. 528/12; 556/442; 556/173; 556/9; 556/437

(57) ABSTRACT

The invention relates to the use of organofunctional carboxy compounds as catalysts for silane hydrolysis and/or catalysts for silanol condensation, wherein according to the invention, the term carboxy compounds refers to an organic acid, preferably an organic carboxylic acid with 4 to 46 carbon atoms, such as fatty acids, or an organic acid precursor compound containing silicon, an α-carboxysilane ((R³—(CO)O)_{4-z-x}SiR²ₓ(A)_{z}, α-Si-oxycarbonyl-R³), or an organic acid precursor compound which does not contain silicon. The term organic acid precursor compound means esters, lactones, anhydrides, salts of organic cations. The invention also relates to the use of at least one organofunctional carboxy compound for the surface modification of substrates, the substrates modified with the same, and a kit for use in the production of the substrate.

The invention relates to the use of organofunctional carboxy compounds as silane hydrolysis catalyst and/or silanol condensation catalyst, where carboxy compounds in the invention are an organic acid, preferably an organic carboxylic acid having from 4 to 46 carbon atoms, examples being fatty acids, or a silicon-containing precursor compound of an organic acid, an α-carboxysilane ((R³—(CO)O)_{4-z-x}SiR²ₓ(A)_{z}, α-Si-oxycarbonyl-R³), or a silicon-free precursor compound of an organic acid. Precursor compounds of an organic acid here are esters, lactones, anhydrides, and salts of organic cations. The invention further relates to the use of at least one organofunctional carboxy compound for the surface-modification of substrates, to the substrates modified therewith, and also to a kit for use in the production of the substrates.

Many applications currently either use tin-containing catalyst systems or omit the use of catalysts because of their toxicity. A general feature of the organotin compounds is significant toxicity, for example of dibutyltin compounds.

Examples of silanol condensation catalysts used hitherto for the production of moisture-crosslinkable filled and unfilled compounded polymer materials, in particular of polyethylene (PE) and its copolymers, for the crosslinking of silane-grafted or silane-copolymerized polyethylenes, or of other polymers, are organotin compounds or aromatic sulfonic acids (Borealis Ambicat®). A disadvantage of the organotin compounds is that they are significantly toxic, while the sulfonic acids are notable for their pungent odor, which continues through all stages of the process into the final product. The compounded polymer materials crosslinked by sulfonic acids are generally not suitable for use in the food-and-drink sector or in the drinking-water-supply sector, for example for production of drinking-water pipes, because of reaction byproducts. Dibutyltin dilaurate (DBTDL) and dioctyltin dilaurate (DOTL) are conventional tin-based silanol condensation catalysts, and act as catalyst by way of their coordination sphere.

EP 207 627 discloses further tin-containing catalyst systems and copolymers modified therewith, based on the reaction of dibutyltin oxide with ethylene-acrylic acid copolymers. JP 58013613 uses Sn(acetyl)₂ as catalyst, and JP 05162237 teaches the use of carboxylates of tin, of zinc, or of cobalt, together with hydrocarbon groups, as silanol condensation catalysts, examples being dioctyltin maleate, monobutyltin oxide, dimethyloxybutyltin, or dibutyltin diacetate. JP 3656545 uses zinc and aluminum soaps for crosslinking, examples being zinc octylate and aluminum laurate. JP 1042509 likewise discloses the use of organotin compounds for crosslinking of silanes, but also discloses alkyl titanic esters based on titanium chelate compounds.

Polyurethanes, too, are crosslinked in the presence of metal-containing catalysts in JP 2007045980. The catalyst system mentioned in that document is composed of a beta-diketone complex with metals, such as cobalt, and a tertiary amine and acids.

The fatty acid reaction products of functional trichlorosilanes have generally been known since the 1960s, in particular as lubricant additions. DE 25 44 125 discloses the use of dimethyldicarboxysilanes as lubricant addition in the coating of magnetic tapes. The compound has sufficient resistance to hydrolysis in the absence of strong acids and bases.

It is an object of the present invention to develop new silane hydrolysis catalysts and/or new silanol condensation catalysts, where these do not have the abovementioned disadvantages of the catalysts known from the prior art, and can preferably be homogenized or dispersed with organofunctional silanes, and/or with organofunctional siloxanes, or else with silane-grafted or silane-copolymerized polymers, monomers, or prepolymers. It is preferable that the silane hydrolysis catalysts and/or silanol condensation catalysts are liquid or waxy to solid, and/or have been encapsulated or applied to a carrier material.

The object is achieved by the use in the invention corresponding to the features of claims 1 and 2, and also by the substrate as in claim 7, and also the kit as in claim 12, and also the process as in claim 13 and the composition as in claim 15. The invention also provides a silane-terminated, in particular metal-free, polyurethane. The dependent claims and the description provide preferred embodiments.

Surprisingly, it has been found that carboxy compounds, in particular of an organic carboxylic acid having from 4 to 46 carbon atoms, examples being fatty acids, or a silicon-containing precursor compound of an organic acid, in particular of a long-chain carboxylic acid, or a corresponding silicon-free precursor compound of an organic acid, an example being an organofunctional salt or anhydride, can be used as silane hydrolysis catalyst and/or silanol condensation catalyst. It was particularly surprising that silicon-containing precursor compounds of an organic acid can be used as silane hydrolysis catalyst and/or silanol condensation catalyst, in particular as catalyst for the hydrolysis of organofunctional silanes or of oligomeric organofunctional siloxanes, and also as catalyst for the crosslinking or, respectively, condensation of silanols or of siloxanes or with other functional groups capable of condensation in substrates, for example with hydroxyfunctionalized silicon compounds or hydroxyfunctionalized substrates (HO—Si or HO substrate).

When the systems catalyzed with the carboxy compounds of the invention, in particular with fatty acids and/or with silicon-containing precursor compounds of an organic acid, in particular of a fatty acid, are compared with standard systems with, for example, HCl or acetic acid, they have longer pot life, and the systems also have markedly improved shelf life.

When the coated fillers of the invention are compared with the uncatalyzed systems, they exhibit faster hardening, and also a shorter afterreaction time. The use of the carboxy compounds in the invention can therefore increase throughput during the production of coated substrates, in particular of the fillers, such as the flame-retardant fillers. This measure makes production markedly more cost-effective.

A general requirement placed upon the precursor compound is that it is hydrolyzable, in particular in the presence of moisture, and can thus liberate the free organic acid, in particular under the given process conditions for the respective process. In the invention, the silicon-containing precursor compound of the organic acid is hydrolyzable with supply of heat, preferably in the molten state, in the presence of moisture, and liberates the organic acid completely or at least to some extent.

The invention uses at least one organofunctional carboxy compound as silane hydrolysis catalyst and/or silanol condensation catalyst, and/or for the surface-modification of substrates, in particular of substrates having functional groups capable of condensation or of reaction, examples being HO-functionalized substrates, silicates, passivated metals, oxidic compounds, zeolites, granite, quartz, and also other substrates familiar to the person skilled in the art.

In the invention, carboxy compounds of an organic acid are carboxylic acids having from 4 to 46 carbon atoms, examples being unsaturated, or mono- or polyunsaturated fatty acids, synthetic or natural, which can also have been further functionalized, or a silicon-containing precursor compound of an organic acid, an example being mono-, di-, tri-, or tetra-α-carboxysilane, which can therefore liberate an acid in accordance with above definition, or a precursor compound of an organic acid, e.g. an ester, lactone, anhydride, or salt of an organic compound of the acid, for example of an organic cation, or an ammonium or iminium salt of a corresponding acid, or of correspondingly protonated secondary or tertiary amines or N-containing heterocycles, where these can be dispersed in the silanes or siloxanes. The acid liberated corresponds to the above definition of a carboxylic acid having from 4 to 46 carbon atoms, preferably having from 8 to 22 carbon atoms.

In the invention, the organofunctional carboxy compound has been selected from

b.1) a silicon-containing precursor compound of an organic acid of the general formula IVa,

(A)_{z}SiR²ₓ(OR¹)_{4-z-x} (IVa)

(R¹O)_{3-y-u}(R²)ᵤ(A)_{y}Si-A-Si(A)_{y}(R²)ᵤ(OR¹)_{3-y-u} (IVb)
where, mutually independently, z is 0, 1, 2, or 3, x is 0, 1, 2, or 3, y is 0, 1, 2, or 3 and u is 0, 1, 2, or 3, with the proviso that in formula IVa z+x is smaller than or equal to (≦) 3 and in formula IVb y+u is independently smaller than or equal to (≦) 2,
A is mutually independently in formula IVa and/or IVb a monovalent organofunctional group, and A in the form of divalent moiety in formula IVb is a divalent organofunctional group,
R¹ corresponds mutually independently to a carbonyl-R³ group, where R³ corresponds to a moiety having from 1 to 45 carbon atoms, in particular to a saturated or unsaturated hydrocarbon moiety (HC moiety), which can be an unsubstituted or substituted moiety,
R² is mutually independently a hydrocarbon group, and/or
   b.2) an organic acid selected from the group of
iii.a) a carboxylic acid comprising from 4 to 45 carbon atoms,
iii.b) a saturated and/or unsaturated fatty acid, and/or
iii.c) a natural or synthetic amino acid, and/or
   b.3) a silicon-free precursor compound of an organic acid,
   in particular an anhydride, ester, lactone, or salt of an organic cation, or a natural or synthetic triglyceride, and/or phosphoglyceride,
   and, in the presence of at least one organofunctionalized silane, in particular of an alkoxysilane; and/or of at least one linear, branched, cyclic, and/or three-dimensionally crosslinked oligomeric organofunctionalized siloxane, and/or their mixtures, and/or condensates and, if appropriate, in the presence of a substrate, acts as silane hydrolysis catalyst and/or silanol condensation catalyst, and/or as catalyst for, or during, the surface-modification of substrates.

It is preferable in formula IVa that z=1 and x=0 or that z=0 and x=1 for the tricarboxysilanes and/or that for the tetracarboxysilanes z=0 and x=0, or that for dicarboxysilanes z=1 and x=1. Alternative preference can be given to z=2.

A (b.1) silicon-containing precursor compound of an organic acid is not a terminal carboxysilane compound and in the invention is a compound of the general formula IVa,

(A)_{z}SiR²ₓ(OR¹)_{4-z-x} (IVa)

(R¹O)_{3-y-u}(R²)ᵤ(A)_{y}Si-A-Si(A)_{y}(R²)ᵤ(OR¹)_{3-y-u} (IVb)
where, mutually independently, z is 0, 1, 2, or 3, x is 0, 1, 2, or 3, y is 0, 1, 2, or 3 and u is 0, 1, 2, or 3, with the proviso that in formula IVa z+x is smaller than or equal to (≦) 3 and in formula IVb y+u is independently smaller than or equal to (≦) 2, where, in one embodiment, z is preferably 1 and can advantageously also be 2 or 3, and in another preferred embodiment z is 0, for tetra-α-carboxysilanes, and, for corresponding compounds of the formula IVb, y and u can both be 0, for a bis(tris-α-carboxydisilane),
A is mutually independently in formula IVa and/or IVb a monovalent organofunctional group, and A in the form of divalent moiety in formula IVb is a divalent organofunctional group,
A, in the form of organofunctional group, can preferably mutually independently correspond in formula IVa and/or IVb to an alkyl-, alkenyl-, aryl-, epoxy-, dihydroxyalkyl-, aminoalkyl-, polyalkylglycolalkyl-, haloalkyl-, mercaptoalkyl-, sulfanalkyl-, ureidoalkyl-, and/or acryloxyalkyl-functional group, in particular to a linear, branched, and/or cyclic alkyl moiety having from 1 to 18 carbon atoms, and/or a linear, branched, and/or cyclic alkoxy, alkoxyalkyl, arylalkyl, aminoalkyl, haloalkyl, polyether, alkenyl, alkynyl, epoxy, methacryloxyalkyl, and/or acryloxyalkyl group having from 1 to 18 carbon atoms, and/or an aryl group having from 6 to 12 carbon atoms, and/or a ureidoalkyl, mercaptoalkyl, cyanoalkyl, and/or isocyanoalkyl group having from 1 to 18 carbon atoms, and A can in particular correspond to a polyether of the formulae H₃C—(O—CH₂—CH₂—)ₙO—CH₂—, H₃C—(O—CH₂—CH₂—CH₂—)ₙO—CH₂—, H₃C—(O—CH₂—CH₂—CH₂—CH₂—)ₙO—CH₂—, H₃C—(O—CH₂—CH₂—)ₙO—, H₃C—(O—CH₂—CH₂—CH₂—)ₙO— and/or H₃C—(O—CH₂—CH₂—CH₂—CH₂—)ₙO—, having a chain length n of from 1 to 300, in particular from 1 to 180, preferably from 1 to 100, and/or an isoalkyl group having from 1 to 18 carbon atoms, a cycloalkyl group having from 1 to 18 carbon atoms, an example being a cyclohexyl group, a 3-methacryloxypropyl group, a 3-acryloxypropyl group, methoxy group, or ethoxy group, or propoxy groups, or a fluoroalkyl group, vinyl group, 3-glycidyloxypropyl group, and/or allyl group, and/or

A can also correspond to a:

1) monovalent olefin group, a particular example being —(R⁹)₂C═C(R⁹)-M*ₖ-, in which R⁹ are identical or different, and R⁹ is a hydrogen atom or a methyl group, or a phenyl group, the group M* represents a group from —CH₂—, —(CH₂)₂—, —(CH₂)₃—, —O(O)C(CH₂)₃— or —C(O)O—(CH₂)₃—, k is 0, or 1, examples being vinyl, allyl, 3-methacryloxypropyl, and/or acryloxypropyl, n-3-pentenyl, n-4-butenyl, or isoprenyl, 3-pentenyl, hexenyl, cyclohexenyl, terpenyl, squalanyl, squalenyl, polyterpenyl, betulaprenoxy, cis/trans-polyisoprenyl, or
comprises R⁸—F_{g}—[C(R⁸)═C(R⁸)—C(R⁸)═C(R⁸)]ᵣ—F_{g}—, in which R⁸ are identical or different and R⁶ is a hydrogen atom or an alkyl group having from 1 to 3 carbon atoms, or an aryl group, or an aralkyl group, preferably a methyl group or a phenyl group, groups F are identical or different, and F is a group from —CH₂—, —(CH₂)₂—, —(CH₂)₃—, —O(O)C(CH₂)₃—, or —C(O)O—(CH₂)₃—,
   r is from 1 to 100, in particular 1 or 2, and g is 0 or 1,
and, in formula IVb, A in the form of a divalent moiety can be an olefin moiety in formula IVb, examples being the corresponding alkenylenes, such as 2-pentenylene, 1,3-butadienylene, iso-3-butenylene, pentenylene, hexenylene, hexendienylene, cyclohexenylene, terpenylene, squalanylene, squalenylene, polyterpenylene, or cis/trans-polyisoprenylene, and/or
   2) an A can mutually independently both in IVa and in IVb be a monovalent amino-functional moiety or a divalent amino-functional moiety in IVb, and in particular A can correspond to an aminopropyl-functional group of the formula
   —(CH₂)₃—NH₂, —(CH₂)₃—NHR′, —(CH₂)₃—NH(CH₂)₂—NH₂ and/or —(CH₂)₃—NH(CH₂)₂—NH(CH₂)₂—NH₂, in which R′ is a linear, branched, or cyclic alkyl group having from 1 to 18 carbon atoms, or an aryl group having from 6 to 12 carbon atoms,
A can correspond to one of the following amino-functional groups of the general formula Va or Vb

R¹⁰_{h*}NH_{(2-h*)}[(CH₂)ₕ(NH)]ⱼ[(CH₂)ₗ(NH)]ₙ—(CH₂)ₖ— (Va)

in which 0≦h≦6; h*=0, 1 or 2, j=0, 1 or 2; 0≦l≦6; n=0, 1, or 2;
0≦k≦6 in Va, and R¹⁰ correspond to a benzyl, aryl, vinyl, or formyl moiety and/or to a linear, branched, and/or cyclic alkyl moiety having from 1 to 8 carbon atoms, and/or

[NH₂(CH₂)ₘ]₂N(CH₂)ₚ— (Vb)

where 0≦m≦6 and 0≦p≦6 in Vb.
A in IVb can correspond to a divalent bisamino-functional group of the formula VI,

(CH₂)ₗ—[NH(CH₂)_{f}]_{g}NH[(CH₂)_{f*}NH]_{g*}—(CH₂)_{i*}— (Vc)

where, in formula Vc, i, i*, f, f*, g, and g* are identical or different, where i and/or i*=from 0 to 8, f and/or f*=1, 2, or 3, and g and/or g*=0, 1, or 2, and
3) A can correspond to an epoxy moiety and/or ether moiety, in particular to a 3-glycidoxyalkyl, 3-glycidoxypropyl, epoxyalkyl, epoxycycloalkyl, epoxycyclohexyl, or polyalkylglycolalkyl moiety, or to a polyalkylglycol-3-propyl moiety, or to the corresponding ring-opened epoxides, which take the form of diols.
4) A can correspond to a haloalkyl moiety, an example being R⁸*—Y_{m*}—(CH₂)_{s*}—, where R⁸* corresponds to a mono-, oligo-, or perfluorinated alkyl moiety having from 1 to 9 carbon atoms, or to a mono-, oligo-, or perfluorinated aryl moiety, where moreover Y corresponds to a CH₂, O, aryl, or S moiety, and m*=0 or 1, and s*=0 or 2, and/or
5) A can correspond to a sulfanalkyl moiety, where the sulfanalkyl moiety corresponds to the general formula VII with —(CH₂)_{q*}—X—(CH₂)_{q*}—, where q*=1, 2, or 3, X═Sₚ, where the average of p corresponds to 2 or, respectively, 2.18 or to 4 or, respectively, 3.8, with from 2 to 12 sulfur atoms distributed within the chain, and/or
6) A can be a polymer, in particular a silane-terminated polyurethane prepolymer-NH—CO-nBuN-(CH₂)₃—; a polyethylene polymer, a polypropylene polymer, an epoxy resin, or any other polymer familiar to the person skilled in the art.

The moiety R¹ in the formula IVa and/or IVb can mutually independently correspond to a carbonyl-R³ group, where R³ corresponds to a moiety having from 1 to 45 carbon atoms, in particular to a saturated or unsaturated hydrocarbon moiety (HC moiety), which can be an unsubstituted or substituted moiety, and

R¹ preferably corresponds in formula IVa and/or IVb, mutually independently, to a carbonyl-R³ group, i.e. to a —(CO)R³ group (—(C═O)—R³), so that —OR¹ is —O(CO)R³, where R³ corresponds to an unsubstituted or substituted hydrocarbon moiety (HC moiety), in particular having from 1 to 45 carbon atoms, preferably having from 4 to 45 carbon atoms, in particular having from 6 to 45 carbon atoms, preferably having from 6 to 22 carbon atoms, particularly preferably having from 6 to 14 carbon atoms, with preference having from 8 to 13 carbon atoms, and in particular to a linear, branched, and/or cyclic unsubstituted and/or substituted hydrocarbon moiety, particularly preferably to a hydrocarbon moiety of a natural or synthetic fatty acid, and R³ in R¹ is in particular mutually independently a saturated HC moiety with —CₙH₂ₙ₊₁, where n=4 to 45, examples being —C₄H₉, —C₅H₁₁, —C₆H₁₃, —C₇H₁₅, —C₈H₁₇, —C₉H₁₉, —C₁₀H₂₁, —C₁₁H₂₃, —C₁₂H₂₅, —C₁₃H₂₇, —C₁₄H₂₉, —C₁₅H₃₁, —C₁₆H₃₃, —C₁₇H₃₅, —C₁₈H₃₇, —C₁₉H₃₉, —C₂₀H₄₁, —C₂₁H₄₃, —C₂₂H₄₅, —C₂₃H₄₇, —C₂₄H₄₉, —C₂₅H₅₁, —C₂₆H₅₃, —C₂₇H₅₅, —C₂₈H₅₇, —C₂₉H₈₉, or else preferably an unsaturated HC moiety, for example —C₁₀H₁₉, —C₁₅H₂₉, —C₁₇H₃₃, —C₁₇H₃₃, —C₁₉H₃₇, —C₂₁H₄₁, —C₂₁H₄₁, —C₂₁H₄₁, —C₂₃H₄₅, —C₁₇H₃₁, —C₁₇H₂₉, —C₁₇H₂₉, —C₁₉H₃₁, —C₁₉H₂₉, —C₂₁H₃₃ and/or —C₂₁H₃₁. The relatively short-chain HC moieties R³, examples being —C₄H₉, —C₃H₇, —C₂H₅, —CH₃ (acetyl), and/or R³═H (formyl), can likewise be used in the composition. However, because the HC moieties have low hydrophobicity, compounds of the formula IVa and/or IVb in which R¹ is a carbonyl-R³ group are generally used, selected from the group R³ with an unsubstituted or substituted hydrocarbon moiety having from 4 to 45 carbon atoms, in particular having from 6 to 22 carbon atoms, preferably having from 8 to 22 carbon atoms, particularly preferably having from 6 to 14 carbon atoms, or with preference having from 8 to 13 carbon atoms. The invention uses fatty acids, examples being caprylic acid, oleic acid, lauric acid, capric acid, stearic acid, palmitic acid, behenic acid, and/or myristic acid, and a particularly preferred fatty acid here is one selected from caprylic acid, lauric acid, capric acid, behenic acid, and/or myristic acid.

R² in formula IVa and/or IVb is mutually independently a hydrocarbon group, in particular a substituted or unsubstituted linear, branched, and/or cyclic alkyl, alkenyl, alkylaryl, alkenylaryl, and/or aryl group having from 1 to 24 carbon atoms, preferably having from 1 to 18 carbon atoms; in particular having from 1 to 3 carbon atoms in the case of alkyl groups. Particularly suitable alkyl groups are ethyl, n-propyl, and/or isopropyl groups. Particularly suitable substituted hydrocarbons are halogenated hydrocarbons, examples being 3-halopropyl groups, e.g. 3-chloropropyl or 3-bromo-propyl groups, where these are, if appropriate, susceptible to nucleophilic substitution, or else are groups that can be used in PVC.

It is therefore also preferably possible to use silicon-containing precursor compounds of an organic acid of the general formula IVa and/or IVb which correspond to alkyl-substituted di- or tricarboxysilanes, where z=0 and x=1 or 2. Examples of these are methyl-, dimethyl-, ethyl-, or methylethyl-substituted carboxysilanes based on caprylic acid, capric acid, myristic acid, stearic acid, palmitic acid, behenic acid, oleic acid, or lauric acid, preferably based on myristic acid.

The term carbonyl-R³ groups means the acid moieties of the organic carboxylic acids, as in R³—(CO)—, where these in the form of carboxy group corresponding to the formulae have bonding to the Si—OR¹ silicon, as stated above. In general terms, the acid moieties of the formula I and/or II can be obtained from naturally occurring or synthetic fatty acids, examples being the following saturated fatty acids: valeric acid (pentanoic acid, R³═C₄H₉), caproic acid (hexanoic acid, R³═C₅H₁₁), enanthic acid (heptanoic acid, R³═C₆H₁₃), caprylic acid (octanoic acid, R³═C₇H₁₅), pelargonic acid (nonanoic acid R³═C₈H₁₇), capric acid (decanoic acid, R³═C₉H₁₉), lauric acid (dodecanoic acid R³═C₉H₁₉), undecanoic acid (R³═C₁₀H₂₃), tridecanoic acid (R³═C₁₂H₂₅), myristic acid (tetradecanoic acid, R³═C₁₃H₂₇), pentadecanoic acid (R³═C₁₄H₂₉), palmitic acid (hexadecanoic acid, R³═C₁₅H₃₁), margaric acid (heptadecanoic acid, R³═C₁₆H₃₃), stearic acid (octadecanoic acid, R³═C₁₇H₃₅), nonadecanoic acid (R³═C₁₈H₃₇), arachic acid (eicosanoic/icosanoic acid, R³═C₁₉H₃₉), behenic acid (docosanoic acid, R³═C₂₁H₄₃), lignoceric acid (tetracosanoic acid, R³═C₂₃H₄₇), cerotinic acid (hexacosanoic acid, R³═C₂₅H₅₁), montanic acid (octacosanoic acid, R³═C₂₇H₅₅), and/or melissic acid (triacontanoic acid, R³═C₂₉H₅₉), and also the short-chain unsaturated fatty acids, such as valeric acid (pentanoic acid, R³═C₄H₉), butyric acid (butanoic acid, R³═C₃H₇), propionic acid (propanoic acid, R³═C₂H₅), acetic acid (R³═CH₃), and/or formic acid (R³═H), and can be used as silicon-containing precursor compound of the formula IVa and/or IVb of the otherwise purely organic silane hydrolysis catalysts and/or silanol condensation catalysts.

However, preference is given to using fatty acids in the formula IVa and/or IVb having a hydrophobic HC moiety, where these are sufficiently hydrophobic or lipophilic or, in an organofunctional silane or organofunctional siloxane or, if appropriate, in a mixture of one or both compounds, and also, if appropriate, in the presence of a substrate, are appropriately dispersible or homogenizable with the compounds, and have no unpleasant odor after liberation, and do not exude from the substrates or polymers produced. An HC moiety is sufficiently hydrophobic if the acid is homogenizable or dispersible in the silane, in the siloxane, and/or in a mixture, if appropriate with the substrate and, if appropriate, with a polymer or with a monomer or prepolymer.

Preferred acid moieties in the formulae IVa and/or IVb derive from the following acids: capric acid, caprylic acid, stearic acid, palmitic acid, oleic acid, lauric acid, and myristic acid; it is also possible to use behenic acid, but myristic acid is preferred.

It is equally preferably possible to react the naturally occurring or synthetic unsaturated fatty acids to give the precursor compounds of the formula IVa and/or IVb. They can simultaneously perform two functions, firstly serving as silane hydrolysis catalyst and/or as silanol condensation catalyst, and, by virtue of their unsaturated hydrocarbon moieties, participating directly in any ionic or free-radical polymerization reaction that may be desired. Preferred unsaturated fatty acids are sorbic acid (R³═C₅H₇), undecylenic acid (R³═C₁₀H₁₉), palmitoleic acid (R³═C₁₅H₂₉), oleic acid (R³═C₁₇H₃₃), elaidic acid (R³═C₁₇H₃₃), vaccenic acid (R³═C₁₉H₃₇), icosenoic acid (R³═C₂₁H₄₁), cetoleic acid (R³═C₂₁H₄₁), erucic acid (R³═C₂₁H₄₁), nervonic acid (R³═C₂₃H₄₅), linoleic acid (R³═C₁₇H₃₁), alpha-linolenic acid (R³═C₁₇H₂₉), gamma-linolenic acid (R³═C₁₇H₂₉), arachidonic acid (R³═C₁₉H₃₁), timnodonic acid (R³═C₁₉H₂₉), clupanodonic acid (R³═C₂₁H₃₃), ricinoleic acid (12-hydroxy-9-octadecenoic acid, R³═C₁₇H₃₃O), and/or cervonic acid (R³═C₂₁H₃₁).

Particular preference is given to precursor compounds of the formula IVa and/or IVb comprising at least one moiety of oleic acid (R³═C₁₇H₃₃).

Other useful acids from which the precursor compounds of the formula IVa and/or IVb having R³—COO or R¹O can be produced are glutaric acid, lactic acid (R¹ being (CH₃)(HO)CH—), citric acid (R¹ being HOOCCH₂C(COOH)(OH)CH₂—), vulpic acid, terephthalic acid, gluconic acid, and adipic acid, where it is also possible that all of the carboxy groups have been Si-functionalized, benzoic acid (R¹ being phenyl), nicotinic acid (vitamin B3 or B5). However, it is also possible to use the natural or synthetic amino acids, in such a way that R¹ corresponds to appropriate moieties such as those deriving from tryptophan, L-arginine, L-histidine, L-phenylalanine, or L-leucine, where L-leucine can be used with preference. It is also correspondingly possible to use the corresponding D-amino acids or a mixture of L- and D-amino acids, or an acid such as D[(CH₂)_{d})COOH]₃, where D=N, P, and d independently=1 to 12, preferably 1, 2, 3, 4, 5, or 6, in which the hydroxy group of each carboxylic acid function can independently have been Si-functionalized.

It is therefore also possible to use corresponding compounds of the formula IVa and/or IVb based on moieties of said acids as silane hydrolysis catalyst and/or silanol condensation catalyst.

The silicon-containing precursor compound of an organic acid is in particular active in hydrolyzed form as silane hydrolysis catalyst and/or silanol condensation catalyst by way of the liberated organic acid, and is also itself, in hydrolyzed or nonhydrolyzed form, capable of reaction at the organofunctional moiety, whereby of example it is possible for a secondary amine to react with a polyurethane prepolymer, or to be grafted onto a polymer, and/or to be copolymerized with a prepolymer or parent polymer, or is suitable for crosslinking, for example in the form of adhesion promoter. In hydrolyzed form, the silanol compound formed contributes to crosslinking by means of resultant Si—O—Si siloxane bridges and/or Si—O substrate or, respectively, carrier material bonds, during the condensation reaction. Said crosslinking can use other silanols or siloxanes, or can generally use functional groups which are suitable for the crosslinking process and which are present on substrates, on fillers, and/or on carrier materials, and/or construction elements, in particular on inorganic substrates, such as mortar, tiles, concrete, aluminates, silicates, metals, metal alloys, and also other substrates which are familiar to the person skilled in the art and which are oxidic and/or which have hydroxy groups.

Preferred fillers and/or carrier materials are therefore aluminum hydroxides, magnesium hydroxides, fumed silica, precipitated silica, silicates, and also other fillers and carrier materials mentioned hereinafter.

Very particularly preferred precursor compounds are organofunctional A-silane trimyristates, A-silane tricaprylates, A-silane tricaprinates, A-silane trioleates, or A-silane trilaurates, where A is defined as above, vinylsilane trimyristate, vinylsilane trilaurate, vinylsilane tricaprate, and also corresponding alkylsilane compounds, or else amino-functional silane compounds of the abovementioned acids, and/or silane tetracarboxylates Si(OR¹)₄, examples being silane tetramyristate, silane tetralaurate, silane tetracaprate, and mixtures of these compounds.

R² is mutually independently in IVa and/or IVb a hydrocarbon group, and R² is preferably methyl, ethyl, isopropyl and/or n-propyl, or else an octyl group.

The production of the carboxysilanes has been known for a long time to the person skilled in the art. By way of example, U.S. Pat. No. 4,028,391 discloses processes for their production in which chlorosilanes are reacted with fatty acids in pentane. U.S. Pat. No. 2,537,073 discloses another process. By way of example, the acid can be heated at reflux directly in a nonpolar solvent, such as pentane, with trichlorosilane or with a functionalized trichlorosilane, in order to obtain the carboxysilane. For the production of tetracarboxysilanes, by way of example, tetrachlorosilane is reacted with the corresponding acid in a suitable solvent (Zeitschrift für Chemie (1963), 3(12), 475-6). Other processes relate to the reaction of the salts or anhydrates of the acids with tetrachlorosilane or with functionalized trichlorosilanes. By way of example, functionalized trichlorosilanes can be reacted with magnesium salts of the organic acids. The transesterification of the carboxylic acids is another possibility.

According to another alternative, the amino-functional silane tricarboxylates of the invention can be produced by reaction of 3-halopropylsilane tricarboxylates with ammonia, with ethyleneamine, or with other primary and/or secondary alkylamines. This method can produce either the amino-functional tricarboxysilanes or else the diamino-functional tricarboxysilanes.

The term organic acids means carboxylic acids which have no sulfate groups or sulfonic acid groups, in particular being organic acids corresponding to R³—COOH; the term silicon-free precursor compound also includes the anhydrides, esters, or salts, in particular organic-cation salts, of said organic acids, and they particularly preferably have a long-chain, nonpolar, in particular substituted or unsubstituted hydrocarbon moiety, where the hydrocarbon moiety can be a saturated or unsaturated moiety, and by way of example R³ can have from 1 to 45 carbon atoms and, if appropriate, can have further organic groups, with the exception of sulfonic acid groups and of sulfate groups. R³ is preferably a hydrocarbon moiety having from 1 to 45 carbon atoms, in particular having from 4 to 45 carbon atoms, preferably having from 8 to 45 carbon atoms, with particular preference having from 6 to 22 carbon atoms, preferably having from 8 to 22 carbon atoms, particularly preferably having from 6 to 14 carbon atoms, with particular preference where R³ is from 8 to 13 carbon atoms, where particular preference is given to R³ being from 11 to 13 carbon atoms, examples here being lauric acid or myristic acid; or hydrogen (R³) and at least one carboxylic acid group (COOH). Organic arylsulfonic acids, such as sulfophthalic acid, and also naphthalenedisulfonic acids, are explicitly excluded from the definition of the organic acids.

Marked preference is therefore given to those acids having long-chain, hydrophobic hydrocarbon moieties. Said acids can also function as dispersing agents and/or as processing aids.

A general requirement placed upon the silicon-containing precursor compound is that it is hydrolyzable under the conditions of the processes and thus liberates the free organic acid. It is preferable that onset of the hydrolysis process does not occur before the crosslinking step of the processes, for example after application to a substrate or a structural element, or else after a shaping process, for example during the heating process, in the presence of moisture, or on entry into a water bath, after a shaping process, or after the shaping process, in the presence of moisture. Compounds excluded from the silicon-free precursor compounds are usefully those which when hydrolyzed give an inorganic and an organic acid. An inorganic acid here does not include a silanol.

Preferred amino-functional tricarboxysilanes are functionalized with myristic acid, with lauric acid, with caprylic acid, with capric acid, with oleic acid, with stearic acid, and/or with palmitic acid. Preference is equally given to alkyl-functional or halogen-functional tricarboxysilanes of the abovementioned acids. The invention uses α-carboxysilane functionalized with myristic acid and with lauric acid.

In the invention, b.2) is an organic acid selected from the group of

iii.a) a carboxylic acid comprising from 4 to 45 carbon atoms, where this definition may include further functional groups,
iii.b) a saturated and/or unsaturated fatty acid, and/or
iii.c) a natural or synthetic amino acid, where as at least one organic acid, iii.b) a saturated and/or unsaturated fatty acid (natural or synthetic) can be, e.g. a saturated fatty acid: valeric acid, caproic acid, enanthic acid, caprylic acid, pelargonic acid, capric acid, lauric acid, undecanoic acid, tridecanoic acid, myristic acid, pentadecanoic acid, palmitic acid, margaric acid, stearic acid, nonadecanoic acid, arachic acid, behenic acid, lignoceric acid, cerotinic acid, montanic acid, melissic acid, valeric acid, butyric acid, propionic acid, acetic acid, formic acid, undecylenic acid, palmitoleic acid, oleic acid, elaidic acid, vaccenic acid, icosenoic acid, cetoleic acid, erucic acid, nervonic acid, linoleic acid, alpha-linolenic acid, gamma-linolenic acid, arachidonic acid, timnodonic acid, clupanodonic acid, cervonic acid, lignoceric acid (H₃C—(CH₂)₂₂—COOH), cerotinic acid, lactic acid, citric acid, benzoic acid, nicotinic acid, arachidonic acid (5,8,11,14-eicosatetraenic acid, C₂₀H₃₂O₂), erucic acid (cis-13-docosenic acid, H₃C—(CH₂)₇—CH═CH—(CH₂)₁₁—COOH), gluconic acid, icosenoic acid (H₃C—(CH₂)₇—CH═CH—(CH₂)₉—COOH), ricinoleic acid (12-hydroxy-9-octadecenoic acid), sorbic acid (C₆H₈O₂), and/or natural or synthetic amino acids, such as tryptophan, L-arginine, L-histidine, L-phenylalanine, L-leucine, where L-leucine is preferred, a dicarboxylic acid, examples being adipic acid, glutaric acid, and terephthalic acid (benzene-1,4-dicarboxylic acid), where lauric acid and myristic acid are preferred, or an acid D[(CH₂)_{d})COOH]₃, where D=N, P, and n=1 to 12, preferably 1, 2, 3, 4, 5, or 6.

The acids having relatively long hydrophobic hydrocarbon moieties, beginning with valeric acid, and preferably capric acid, lauric acid, and/or myristic acid, generally have good suitability as silanol condensation catalyst. The less hydrophobic acids, examples being propionic acid, acetic acid, and formic acid are regarded merely as useful for the reaction with substrates, with organofunctional silanes, and/or organofunctional silanes. Accordingly, the fatty acids with strong odor, examples being butyric acid and caprylic acid, are also merely useful or have low suitability to no suitability for the use as components in a kit or in a process, because of their pungent odor. This applies particularly when the resultant siloxanes, modified substrates, polymers, or compounded polymer materials are utilized directly for the production of drinking-water pipes, or in the food-and-drink sector, or for products in direct contact with food or drink, or else are utilized directly by the end consumer. Further use of the resultant siloxanes or modified substrates can preferably also be in the sector of medical technology, for hoses, etc.

Organic acids are carboxylic acids which have no sulfate groups or sulfonic acid groups, and in particular they are organic acids corresponding to R³—COOH; the anhydrides, esters, or salts of these organic acids can also be regarded as silicon-free precursor compound, and they particularly preferably have a long-chain, nonpolar, in particular substituted or unsubstituted hydrocarbon moiety, where the hydrocarbon moiety can be saturated or unsaturated, for example where R³ is from 1 to 45 carbon atoms, in particular from 4 to 45 carbon atoms, preferably having from 8 to 45 carbon atoms, in particular having from 6 to 22 carbon atoms, preferably having from 8 to 22 carbon atoms, particularly preferably having from 6 to 14 carbon atoms, with particular preference where R³ is from 8 to 13 carbon atoms, where particular preference is given to R³ being from 11 to 13 carbon atoms; an example of these materials is lauric acid or myristic acid, or hydrogen (R³) and at least one carboxylic acid group (COOH). Materials explicitly excluded from the definition of the organic acids are organic arylsulfonic acids, examples being sulfophthalic acid, and also naphthalenedisulfonic acids.

Marked preference is therefore given to those acids having long-chain, hydrophobic hydrocarbon moieties. These acids can also function as dispersing agents and/or processing aids. Organic acids that can be used as silanol condensation catalyst are generally the naturally occurring or synthetic fatty acids, examples being the following saturated fatty acids: valeric acid (pentanoic acid, R³═C₄H₉), caproic acid (hexanoic acid, R³═C₅H₁₁), enanthic acid (heptanoic acid, R³═C₆H₁₃), caprylic acid (octanoic acid, R³═C₇H₁₅), pelargonic acid (nonanoic acid R³═C₈H₁₇), capric acid (decanoic acid, R³═C₉H₁₉), lauric acid (dodecanoic acid R³═C₉H₁₉), undecanoic acid (R³═C₁₀H₂₃), tridecanoic acid (R³═C₁₂H₂₅), myristic acid (tetradecanoic acid, R³═C₁₃H₂₇), pentadecanoic acid (R³═C₁₄H₂₉), palmitic acid (hexadecanoic acid, R³═C₁₅H₃₁), margaric acid (heptadecanoic acid, R³═C₁₆H₃₃), stearic acid (octadecanoic acid, R³═C₁₇H₃₅), nonadecanoic acid (R³═C₁₈H₃₇), arachic acid (eicosanoic/icosanoic acid, R³═C₁₉H₃₉), behenic acid (docosanoic acid, R³═C₂₁H₄₃), lignoceric acid (tetracosanoic acid, R³═C₂₃H₄₇), cerotinic acid (hexacosanoic acid, R³═C₂₅H₅₁), montanic acid (octacosanoic acid, R³═C₂₇H₅₅), and/or melissic acid (triacontanoic acid, R³═C₂₉H₅₉), and also the short-chain unsaturated fatty acids, such as valeric acid (pentanoic acid, R³═C₄H₉), butyric acid (butanoic acid, R³═C₃H₇), propionic acid (propanoic acid, R³═C₂H₅), acetic acid (R³═CH₃), and/or formic acid (R³═H) but the abovementioned short-chain unsaturated fatty acids are not suitable as dispersing agents and/or processing aids, and can therefore be absent in preferred compositions. Particular preference is given to lauric acid and/or myristic acid.

Naturally occurring or synthetic unsaturated fatty acids can be used with equal preference, where these can fulfill two functions, on the one hand serving as silanol condensation catalyst, and they can participate directly in the free-radical polymerization process by virtue of their unsaturated hydrocarbon moieties. Preferred unsaturated fatty acids are sorbic acid (R³═C₅H₇), undecylenic acid (R³═C₁₀H₁₉), palmitoleic acid (R³═C₁₅H₂₉), oleic acid (R³═C₁₇H₃₃), elaidic acid (R³═C₁₇H₃₃), vaccenic acid (R³═C₁₉H₃₇), icosenoic acid (R³═C₂₁H₄₁; (H₃C—(CH₂)₇—CH═CH—(CH₂)₉—COOH)), cetoleic acid (R³═C₂₁H₄₁), erucic acid (R³═C₂₁H₄₁; cis-13-docosenoic acid, H₃C—(CH₂)₇—CH═CH—(CH₂)₁₁—COOH), nervonic acid (R³═C₂₃H₄₅), linoleic acid (R³═C₁₇H₃₁), alpha-linolenic acid (R³═C₁₇H₂₉), gamma-linolenic acid (R³═C₁₇H₂₉), arachidonic acid (R³═C₁₉H₃₁, 5,8,11,14-eicosatetraenoic acid, C₂₀H₃₂O₂), timnodonic acid (R³═C₁₉H₂₉), clupanodonic acid (R³═C₂₁H₃₃), ricinoleic acid (12-hydroxy-9-octadecenoic acid, (R³═C₁₇H₃₃O)), and/or cervonic acid (R³═C₂₁H₃₁).

Other useful acids are lignoceric acid (H₃C—(CH₂)₂₂—COOH), cerotinic acid, lactic acid, citric acid, benzoic acid, nicotinic acid (vitamin B3, B5), gluconic acid, and mixtures of these acids. However, it is also possible to use the natural amino acids, or else synthetic amino acids, examples being tryptophan, L-arginine, L-histidine, L-phenylalanine, L-leucine, where L-leucine is preferred, and it is correspondingly also possible to use the corresponding D-amino acids, or a mixture of the amino acids, or a dicarboxylic acid, examples being adipic acid, glutaric acid, and terephthalic acid (benzene-1,4-dicarboxylic acid), or else an acid such as D[(CH₂)_{d})COOH]₃, where D=N, P, and n=1 to 12, preferably 1, 2, 3, 4, 5, or 6, and/or

3.b) encompassing a silicon-free precursor compound of an organic acid, e.g. an organic anhydride or an ester, in particular of the abovementioned acids, or else the natural or synthetic triglycerides occurring in fats and in oils, and in particular neutral fats, and/or phosphoglycerides, examples being lecithin, phosphatidylethanolamine, phosphatidylinositol, phosphatidylserine and/or diphosphatidylglycerol, or salts, examples being salts of organofunctional cations, such as quaternary ammonium salts having alkyl chains, or conventional ionic phase-transfer catalysts. It is also possible to use synthetic triglycerides, alongside naturally occurring vegetable- and animal-derived triglycerides.

A general requirement placed upon the precursor compound (Si-free and/or Si-containing) is that it is hydrolyzable under the respective process conditions and thus liberates the free organic acid. It is preferable that the onset of the hydrolysis does not precede the crosslinking step of the processes, and that in particular it occurs after the mixing process, application process, and/or shaping process, for example by addition of moisture and, if appropriate, heat. Compounds excluded from the silicon-free precursor compounds are usefully those which when hydrolyzed give an inorganic and an organic acid. An inorganic acid here does not include a silanol. By way of example, silicon-free precursor compounds are not acyl chlorides or generally any corresponding acyl halides of the abovementioned organic acids. Nor are organic acid peroxides regarded as a silicon-free precursor compound.

The abovementioned carboxy compounds are used in the presence of at least one organofunctionalized silane; and/or of at least one linear, branched, cyclic, and/or three-dimensionally crosslinked oligomeric organofunctionalized siloxane, and/or a mixture of these, and, if appropriate, in the presence of the substrate, as silane hydrolysis catalyst and/or silanol condensation catalyst, and/or as catalyst for, or during, the surface-modification of substrates. A surface-modification is preferably the formation of a covalent bond by a condensation step. As an alternative, the surface-modification can also take place by ionic or free-radical reaction of unsaturated carboxy compounds with the substrate. Preference is equally given to bonding by way of supramolecular interactions, in particular hydrogen bonds, in particular of the carboxy compound or of its reaction products.

In the invention, the organofunctional silicon compound has bonding to the substrate, as also, if appropriate, does a reaction product of the organofunctional carboxy compound. In the invention, this bonding can be covalent or else supramolecular.

Organofunctionalized silanes and/or organofunctionalized siloxanes that can be used in the invention can correspond to

a.1) at least one organofunctional silane, in particular one alkoxysilane of the general formula III

(B)_{b}SiR⁴ₐ(OR⁵)_{4-b-a} (III)
where mutually independently b is 0, 1, 2, or 3 and a is 0, 1, 2, or 3, with the proviso that in formula III b+a is smaller than or equal to (≦) 3,
where B is mutually independently a monovalent organofunctional group in formula III,
R⁵ is mutually independently methyl, ethyl, n-propyl, and/or isopropyl,
R⁴ is mutually independently a substituted or unsubstituted hydrocarbon group, and/or
   a.2) to at least one linear, branched, cyclic, and/or three-dimensionally crosslinked oligomeric, organofunctionalized siloxane, where the siloxane having noncyclic and/or cyclic structural elements is represented in idealized form by the two general formulae I and II, where the crosslinked structural elements can lead to three-dimensionally crosslinked siloxane oligomers,

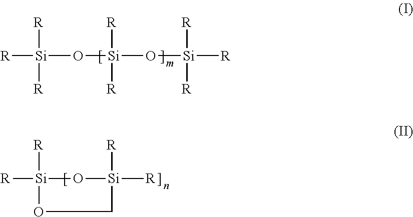

where the substituents R of the noncyclic, cyclic, and/or crosslinked structural elements are composed of organic moieties and/or of hydroxy groups, and the degree of oligomerization m for oligomers of the general formula I is in the range 0≦m<50, preferably 0≦m<30, particularly preferably 0≦m<20 and, for oligomers of the general formula II, n is in the range 2≦n≦50, preferably 2≦n≦30, and/or
a.3) to a mixture of at least two of the abovementioned compounds of the general formula I, II, and/or III, and/or
a.4) to a mixture in the form of a reaction product of at least two of the abovementioned compounds of the formula I, II, and/or III, and/or to their condensates or cocondensates, and/or block cocondensates.

The organofunctional silanes per se are known from the prior art and can be produced as in the disclosure of EP 0 518 057.

When the systems catalyzed with the carboxy compounds of the invention, in particular with fatty acids and/or with silicon-containing precursor compounds of an organic acid, in particular of a fatty acid, are compared with standard systems with, for example, HCl or acetic acid as catalyst, they have longer pot life. Overall, when using these systems it is possible to achieve improved shelf life and higher flexibility.

It is preferable that the

a.1) organofunctional silanes in particular correspond to an alkoxysilane of the general formula III

(B)_{b}SiR⁴ₐ(OR⁵)_{4-b-a} (III)
where mutually independently b is 0, 1, 2, or 3 and a is 0, 1, 2, or 3, with the proviso that in formula III b+a is smaller than or equal to (≦) 3, and, for a tetraalkoxysilane, b and a are 0. Preferred tetraalkoxysilanes are tetramethoxysilane, tetraethoxysilane, and mixtures of the abovementioned alkoxysilanes; for trimethoxy-, triethoxy-, and/or tripropoxysilanes, a or b is 0; for diethoxy- or dimethoxysilanes, b is 1 and a is 1, or b is 2, or a is 2;
where B is mutually independently a monovalent organofunctional group in formula III,
R⁵ is mutually independently methyl, ethyl, n-propyl, and/or isopropyl,
R⁴ is mutually independently a substituted or unsubstituted hydrocarbon group, preferably methyl, ethyl, propyl, hexyl, or octyl.
B can preferably be mutually independently a monovalent organofunctional group in formula III, where
B is preferably mutually independently in formula III an alkyl-, alkenyl-, aryl-, epoxy-, dihydroxyalkyl-, aminoalkyl-, polyalkylglycolalkyl-, haloalkyl-, mercaptoalkyl-, sulfanalkyl-, ureidoalkyl-, and/or acryloxyalkyl-functional group, and in particular corresponds to a linear, branched, and/or cyclic alkyl moiety having from 1 to 18 carbon atoms, and/or a linear, branched, and/or cyclic alkoxy, alkoxyalkyl, arylalkyl, aminoalkyl, haloalkyl, polyether, alkenyl, alkynyl, epoxy, methacryloxyalkyl, and/or acryloxyalkyl group having from 1 to 18 carbon atoms, and/or an aryl group having from 6 to 12 carbon atoms, and/or a ureidoalkyl, mercaptoalkyl, cyanoalkyl, and/or isocyanoalkyl group having from 1 to 18 carbon atoms, and A can in particular correspond to a polyether of the formulae H₃C—(O—CH₂—CH₂—)ₙO—CH₂—, H₃C—(O—CH₂—CH₂—CH₂—)ₙO—CH₂—, H₃C—(O—CH₂—CH₂—CH₂—CH₂—)ₙO—CH₂—, H₃C—(O—CH₂—CH₂—)ₙO—, H₃C—(O—CH₂—CH₂—CH₂—)ₙO— and/or H₃C—(O—CH₂—CH₂—CH₂—CH₂—)ₙO—, having a chain length n of from 1 to 300, in particular from 1 to 180, preferably from 1 to 100, and/or an isoalkyl group having from 1 to 18 carbon atoms, a cycloalkyl group having from 1 to 18 carbon atoms, a 3-methacryloxypropyl group, a 3-acryloxypropyl group, methoxy group, or ethoxy group, or propoxy groups, or a fluoroalkyl group, vinyl group, 3-glycidyloxypropyl group, and/or allyl group, and/or
B can be a silane-terminated polyurethane prepolymer, in particular a prepolymer-NH—CO-nBuN-(CH₂)₃— or a prepolymer-NR—CO-nBuN-(CH₂)₃—, where R=alkyl, preferably methyl, and/or
B can also correspond to a monovalent olefin group, a particular example being —(R⁹*)₂C═C(R⁹*)-M*_{k*}-, in which R⁹* are identical or different, and R⁹* is a hydrogen atom or a methyl group, or a phenyl group, the group M* represents a group from —CH₂—, —(CH₂)₂—, —(CH₂)₃—, —O(O)C(CH₂)₃— or —C(O)O—(CH₂)₃—, k* is 0, or 1, examples being vinyl, allyl, 3-methacryloxypropyl, and/or acryloxypropyl, n-3-pentenyl, n-4-butenyl, or isoprenyl, 3-pentenyl, hexenyl, cyclohexenyl, terpenyl, squalanyl, squalenyl, polyterpenyl, betulaprenoxy, cis/trans-polyisoprenyl, or —R^{8′}—F_{g′}—[C(R^{8′})═C(R^{8′})—C(R^{8′})═C(R^{8′})]_{r′}—F′_{g′}—, in which R^{8′} are identical or different, and R^{6′} is a hydrogen atom or an alkyl group having from 1 to 3 carbon atoms, or an aryl group, or an aralkyl group, preferably a methyl group or a phenyl group, groups F′ are identical or different, and F′ is a group from —CH₂—, —(CH₂)₂—, —(CH₂)₃—, —O(O)C(CH₂)₃—, or —C(O)O—(CH₂)₃—, r′ is from 1 to 100, in particular 1 or 2, and g′ is 0 or 1;
B can mutually independently in formula III be a monovalent amino-functional moiety, and in particular B can correspond to an aminopropyl-functional group of the formula —(CH₂)₃—NH₂, —(CH₂)₃—NHR′, —(CH₂)₃—NH(CH₂)₂—NH₂ and/or —(CH₂)₃—NH(CH₂)₂—NH(CH₂)₂—NH₂, in which R′ is a linear, branched, or cyclic alkyl group having from 1 to 18 carbon atoms, or an aryl group having from 6 to 12 carbon atoms,
B can be a cycloalkylaminoalkyl moiety or cyclohexylaminoalkyl moiety, e.g. cyclohexylaminopropyl,
B can correspond to one of the following amino-functional groups of the general formula Va* or Vb*

R¹⁰_{h*}NH_{(2-h*)}[(CH₂)ₕ(NH)]ⱼ[(CH₂)ₗ(NH)]ₙ—(CH₂)ₖ— (Va*)

in which 0≦h≦6; h*=0, 1 or 2, j=0, 1 or 2; 0≦l≦6; n=0, 1, or 2;
0≦k≦6 in Va*, and R¹⁰ correspond to a benzyl, aryl, vinyl, or formyl moiety and/or to a linear, branched, and/or cyclic alkyl moiety having from 1 to 8 carbon atoms, and/or

[NH₂(CH₂)ₘ]₂N(CH₂)ₚ— (Vb*)

where 0≦m≦6 and 0≦p≦6 in Vb*.
B can correspond to an epoxy moiety and/or ether moiety, in particular to a 3-glycidoxyalkyl, 3-glycidoxypropyl, epoxyalkyl, epoxycycloalkyl, epoxycyclohexyl, or polyalkylglycolalkyl moiety, or to a polyalkylglycol-3-propyl moiety, or to the corresponding ring-opened epoxides, which take the form of diols;
B can correspond to a haloalkyl moiety, an example being R^{8′}—Y′_{m′}—(CH₂)_{s′}—, where R^{8′} corresponds to a mono-, oligo-, or perfluorinated alkyl moiety having from 1 to 9 carbon atoms, or to a mono-, oligo-, or perfluorinated aryl moiety, where moreover Y′ corresponds to a CH₂, O, aryl, or S moiety, and m′=0 or 1, and s′=0 or 2, and/or
B can correspond to a sulfanalkyl moiety, where the sulfanalkyl moiety corresponds to the general formula VII′ with —(CH₂)_{q′}—X′—(CH₂)_{q′}—, where q′=1, 2, or 3, X′═S_{p′}, where the average of p′ corresponds to 2 or, respectively, 2.18 or to 4 or, respectively, 3.8, with from 2 to 12 sulfur atoms distributed within the chain.

The organofunctional siloxanes can be obtained by the process known to the person skilled in the art, for example as in EP 0 518 057 A1, or else DE 196 24 032 A1, EP 0 518 057, or U.S. Pat. No. 5,282,998.

Preferred organofunctional silanes of the formula III are: alkylsilanes, such as methyltrimethoxysilane, methyltriethoxysilane, ethyltrimethoxysilane, ethyltriethoxysilane, propyltrimethoxysilane, propyltriethoxysilane, n- and isobutyltrimethoxysilane, n- and isobutyltriethoxysilane, n- and isopentyltrimethoxysilane, n- and isopentyltriethoxysilane, n- and isohexyltrimethoxysiiane, n- and isooctyltrimethoxysilane, n- and isooctyltriethoxy-silane, hexadecyltrimethoxysilane, hexadecyltriethoxysilane, octadecyltrimethoxy-silane, octadecyltriethoxysilane, dimethyldimethoxysilane, dimethyldiethoxysilane, n- and isobutylmethyldimethoxysilane, n- and isobutylmethyldiethoxysilane, cyclohexyl-methyldimethoxysilane, diisopropyldimethoxysilane, diisobutyldimethoxysilane, and isobutylisopropyldimethoxysilane, vinylsilanes, such as vinyltrimethoxysilane, vinyltriethoxysilane, and vinyltris(2-methoxyethoxysilane), aminoalkoxysilanes, such as 3-aminopropyltrimethoxysilane, 3-aminopropyltriethoxysilane, N-(n-butyl)-3-aminopropyltrimethoxysilane, 3-aminopropylmethyldiethoxysilane, 3-ureido-propyltrimethoxysilane, 3-ureidopropyltriethoxysilane, N-aminoethyl-3-amino-propyltrimethoxysilane, N-aminoethyl-3-aminopropyltriethoxysilane, triamino-functional propyltrimethoxysilane, and 3-(4,5-dihydroimidazolyl)propyltriethoxysilane, cyclohexylaminopropyltrimethoxysilane, cyclohexylaminopropyltriethoxysilane, cyclohexylaminopropylmethyldimethoxysilane, cyclohexylaminopropylmethyldi-ethoxysilane, glycidic-ether- or glycidylalkyl-functional alkoxysilanes, such as 3-glycidyloxypropyltrimethoxysilane and 3-glycidyloxypropyltriethoxysilane, fluoroalkyl-functional alkoxysilanes, such as tridecafluorooctyltriethoxysilane and tridecafluorooctyltrimethoxysilane, acrylic- or methacrylic-functional alkoxysilanes, such as acryloxypropyltrimethoxysilane, acryloxypropyltriethoxysilane, 3-methacryloxypropyltrimethoxysilane, 3-methacryloxypropyltriethoxysilane, 3-methacryloxy-2-methylpropyltrimethoxysilane, and 3-methacryloxy-2-methylpropyl-triethoxysilane, mercapto-functional alkoxysilanes, such as mercaptopropyl-trimethoxysilane and mercaptopropyltriethoxysilane, sulfane- or polysulfane-functional alkoxysilanes, such as bis(triethoxysilylpropyl) tetrasulfane, bis(trimethoxysilylpropyl) tetrasulfane, bis(triethoxysilylpropyl) disulfane, bis(tri-methoxysilylpropyl) disulfane, bis(triethoxysilylpropyl) sulfane, bis(trimethoxysilyl-propyl) sulfane, bis(triethoxysilylpropyl) pentasulfane, and bis(trimethoxysilylpropyl) pentasulfane.

Preferred organofunctional siloxanes, in particular oligomeric siloxanes corresponding to the idealized formulae I and II, as in a.2), correspond to a linear, branched, cyclic, and/or three-dimensionally crosslinked oligomeric organofunctionalized siloxane, having noncyclic and/or cyclic structural elements, which are represented in idealized form by the two general formulae I and II, where the crosslinked structural elements can lead to three-dimensionally crosslinked siloxane oligomers,

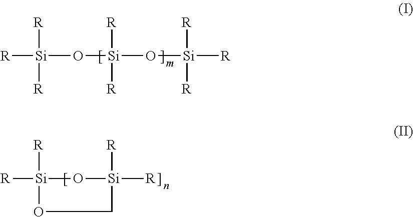

where the substituents R of the noncyclic, cyclic, and/or crosslinked structural elements are composed of organic moieties and/or of hydroxy groups, and the degree of oligomerization m for oligomers of the general formula I is in the range 0≦m<50, preferably 0≦m<30, particularly preferably 0≦m<20 and, for oligomers of the general formula II, n is in the range 2≦n≦50, preferably 2≦n≦30.

It is preferable that the substituents R correspond predominantly or in essence to organic moieties, and preferably only partially to hydroxy groups. Other useful siloxanes are those in which many substituents R correspond to hydroxy groups.

The substituents R of the noncyclic, cyclic, and/or crosslinked structural elements preferably correspond mutually independently to the following organic moieties: a linear, branched, and/or cyclic alkyl moiety having from 1 to 18 carbon atoms, and/or an organofunctional moiety having linear, branched, and/or cyclic alkoxy, alkoxyalkyl, arylalkyl, aminoalkyl, haloalkyl, polyether, alkenyl, alkynyl, epoxy, methacryloxyalkyl and/or acryloxyalkyl group having from 1 to 18 carbon atoms, and/or an aryl group having from 6 to 12 carbon atoms, and/or a ureidoalkyl, mercaptoalkyl, cyanoalkyl, and/or isocyanoalkyl group having from 1 to 18 carbon atoms, particular preference being given to the following organic moieties: linear and/or branched alkoxy groups having from 1 to 4 carbon atoms, and preferably methoxy, ethoxy, 2-methoxyethoxy, and/or propoxy groups, and/or aminopropyl-functional group of the formula —(CH₂)₃—NH₂, —(CH₂)₃—NHR′, —(CH₂)₃—NH(CH₂)₂—NH₂, and/or —(CH₂)₃—NH(CH₂)₂—NH(CH₂)₂—NH₂, in which R′ is a linear, branched, or cyclic alkyl group having from 1 to 18 carbon atoms, or an aryl group having from 6 to 12 carbon atoms, or to a polyether of the formulae H₃C—(O—CH₂—CH₂—)ₙO—CH₂—, H₃C—(O—CH₂—CH₂—CH₂—)ₙO—CH₂—, H₃C—(O—CH₂—CH₂—CH₂—CH₂—)ₙO—CH₂—, H₃C—(O—CH₂—CH₂—)ₙO—, H₃C—(O—CH₂—CH₂—CH₂—)ₙO—, and/or H₃C—(O—CH₂—CH₂—CH₂—CH₂—)ₙO—, with chain length n from 1 to 300, and/or an isoalkyl group having from 1 to 18 carbon atoms, a cycloalkyl group having from 1 to 18 carbon atoms, a 3-methacryloxypropyl group, a 3-acryloxypropyl group, methoxy group, ethoxy group, propoxy groups, fluoroalkyl group, vinyl group, 3-glycidyloxy-propyl group, and/or allyl group. The organic moieties R can also generally mutually independently correspond to the organofunctional groups A and/or B defined above.

The quotient derived from the molar ratio Si/alkoxy groups of preferred oligomer mixtures of the siloxanes of the formulae I and/or II is 0.5, particularly preferably ≧1. It is preferable that an oligomer mixture encompasses n-propylethoxysiloxanes, where the oligomer mixture comprises from 80 to 100% by weight of n-propylethoxysiloxanes where the degree of oligomerization of the oligomers is from 2 to 6, where, in particular for oligomers of the general formula I and/or of the formula II, n is from 1 to 5 and/or m is from 0 to 4.

The degree of oligomerization of the oligomers having noncyclic, cyclic, and/or crosslinked structural elements corresponds to the number of Si units per molecule. In the case of formula I, the degree of oligomerization is two Si units greater than the numeral m, and in the case of formula II it is one Si unit greater. The constitution of each siloxane oligomer is arrived at after taking into account the fact that each oxygen atom of a monomeric siloxane unit can form a bridge between two silicon atoms. The functionality of each individual siloxane unit is therefore also determined by way of the number of possible available oxygen atoms; the organosiloxane units are therefore mono-, di-, tri-, and to some extent tetrafunctional. Structural units available for the structure of siloxane oligomers having noncyclic, cyclic, and/or crosslinked structural elements accordingly comprise the monofunctional element (R)₃—Si—O— indicated by M, the difunctional element —O—Si(R)₂—O— indicated by D, the trifunctional element (—O—)₃SiR, to which the symbol T has been allocated, and the tetrafunctional element Si(—O—)₄ with the symbol Q. The terminology for the structural units is in accordance with their functionality, using the symbols M, D, T, and Q. Once the structural units of which an oligomer is composed are known, conclusions can be drawn about the structural elements. A structural element here can correspond to one section of a possible overall structure of an oligomer, or to the idealized overall structure of an oligomer in a mixture. An oligomer can therefore be composed of noncyclic and also of cyclic and/or simultaneously of crosslinked structural elements. As an alternative, oligomeric siloxanes can also be composed exclusively of noncyclic or cyclic, or crosslinked structural elements.

The oligomeric, organofunctional siloxanes can be used in the presence of the carboxy compounds, in particular of the formula IVa or IVb, and/or of the organic carboxylic acids, preferably where R³ is from 4 to 22 carbon atoms, particularly preferably from 8 to 14 carbon atoms, for the modification of substrates. They particularly have excellent suitability for providing water-repellency to smooth, porous and/or particulate substrates, in particular to inorganic substrates, such as structural elements, in particular of concrete and of porous mineral façade materials.

The mixture of the invention moreover has excellent performance characteristics. Very good penetration depths in concrete can be obtained on application of the oligomeric siloxane mixture of the invention or on application of a composition in the form of an aqueous emulsion into which the oligomeric siloxane has been incorporated, and this is therefore a simple and cost-effective way of achieving excellent impregnation in depth. Substrates treated in the invention also generally exhibit no alteration of color. Furthermore, mixtures of the invention comprising the oligomeric siloxanes and comprising the carboxy compound are generally resistant to evaporation, with excellent shelf life; even in the case of emulsions in water, a 50% strength aqueous emulsion can be used after a period of one year. The present mixture can also be used advantageously in conjunction, in particular in the form of a finished composition, with monomeric, organofunctional silanes, and/or siloxanes, and/or silicic esters.

The following general formula VIII can generally be used as an approximate illustration of the noncyclic n-propylethoxysiloxanes:

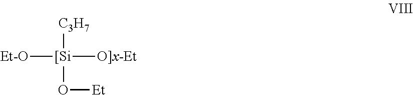

where x gives the degree of oligomerization for the formula VIII. The degree of oligomerization reflects the number of Si units per molecule. To determine the degree of oligomerization for the purposes of the present work the methods used were gel permeation chromatography (GPC method) and 29Si NMR. Where mention is made here of, for example, 100% by weight of an oligomer mixture based on well-defined oligomers, this information is based on the current detection limit of said methods: about 1% of corresponding oligomers.

The present invention also provides the use of a mixture of the invention comprising siloxane oligomers together with the compounds listed below, preferably in the form of a kit, comprising an organofunctional silane and/or an organofunctional siloxane, and/or mixtures of these and/or their condensates, in particular with at least one organofunctional silane from the alkylsilanes, such as methyltrimethoxysilane, methyltriethoxysilane, ethyltrimethoxysilane, ethyltriethoxysilane, propyltrimethoxysilane, propyltriethoxysilane, n- and isobutyltrimethoxysilane, n- and isobutyltriethoxysilane, n- and isopentyltrimethoxysilane, n- and isopentyltriethoxysilane, n- and isohexyltrimethoxysilane, n- and isooctyltrimethoxysilane, n- and isooctyltriethoxysilane, hexadecyltrimethoxysilane, hexadecyltriethoxysilane, octadecyltrimethoxysilane, octadecyltriethoxysilane, dimethyldimethoxysilane, dimethyldiethoxysilane, n- and isobutylmethyldimethoxysilane, n- and isobutylmethyldiethoxysilane, cyclohexyl-methyldimethoxysilane, diisopropyldimethoxysilane, diisobutyldimethoxysilane, and isobutylisopropyldimethoxysilane, vinylsilanes, such as vinyltrimethoxysilane, vinyltriethoxysilane, and vinyltris(2-methoxyethoxysilane), aminoalkoxysilanes, such as 3-aminopropyltrimethoxysilane, 3-aminopropyltriethoxysilane, N-(n-butyl)-3-aminopropyltrimethoxysilane, 3-aminopropylmethyldiethoxysilane, 3-ureido-propyltrimethoxysilane, 3-ureidopropyltriethoxysilane, N-aminoethyl-3-amino-propyltrimethoxysilane, N-aminoethyl-3-aminopropyltriethoxysilane, triamino-functional propyltrimethoxysilane, and 3-(4,5-dihydroimidazolyl)propyltriethoxysilane, cyclohexylaminopropyltrimethoxysilane, cyclohexylaminopropyltriethoxysilane, cyclohexylaminopropylmethyldimethoxysilane, cyclohexylaminopropylmethyldi-ethoxysilane, glycidic-ether- or glycidylalkyl-functional alkoxysilanes, such as 3-glycidyloxypropyltrimethoxysilane and 3-glycidyloxypropyltriethoxysilane, fluoroalkyl-functional alkoxysilanes, such as tridecafluorooctyltriethoxysilane and tridecafluorooctyltrimethoxysilane, acrylic- or methacrylic-functional alkoxysilanes, such as acryloxypropyltrimethoxysilane, acryloxypropyltriethoxysilane, 3-methacryloxypropyltrimethoxysilane, 3-methacryloxypropyltriethoxysilane, 3-methacryloxy-2-methylpropyltrimethoxysilane, and 3-methacryloxy-2-methylpropyl-triethoxysilane, mercapto-functional alkoxysilanes, such as mercaptopropyl-trimethoxysilane and mercaptopropyltriethoxysilane, sulfane- or polysulfane-functional alkoxysilanes, such as bis(triethoxysilylpropyl) tetrasulfane, bis(trimethoxysilylpropyl) tetrasulfane, bis(triethoxysilylpropyl) disulfane, bis(tri-methoxysilylpropyl) disulfane, bis(triethoxysilylpropyl) sulfane, bis(trimethoxysilyl-propyl) sulfane, bis(triethoxysilylpropyl) pentasulfane, and bis(trimethoxysilylpropyl) pentasulfane, where the concentration present of the organofunctional siloxanes can in particular be from 0.5 to 99.5%, based on the mixture, and/or in particular at least one organofunctional siloxane from the following series is used: vinyl-functional siloxanes, vinyl-alkyl-functional siloxanes (cocondensates), methacrylic-functional siloxanes, amino-functional siloxanes, aminoalkyl-alkyl-functional siloxanes, aminoalkyl-fluoroalkyl-functional siloxanes, or corresponding cocondensates, or else the condensates found by way of example in EP 0 590 270 A, EP 0 748 357 A, EP 0 814 110 A, EP 0 879 842 A, EP 0 846 715 A, EP 0 930 342 A, DE 198 18 923 A, DE 199 04 132 A, or else DE 199 08 636 A, and/or at least one silicic ester, e.g. tetramethoxysilane, tetraethoxysilane, tetra-n-propyl silicates, tetrabutyl glycol silicates, and also ethyl polysilicates, and/or at least one oligomeric silicic ester, e.g. DYNASYLAN® 40, or cf. also DE 27 44 726 C, or else DE 28 09 871 C.

In particular, for the purposes of the present invention reference is made to the entire disclosure of above patent specifications relating to siloxane oligomers or to cocondensates, where these can expressly be used.

A mixture of the invention comprising oligomeric, organofunctional siloxanes is preferably suitable for use as oil phase in an aqueous, low- to high-viscosity, emulsion paste, for example as described in EP 0 538 555 A1. By way of example, the siloxane-containing mixture can be used in conjunction by way of example with emulsifiers, buffer, such as sodium carbonate, thickeners, and biocides, in particular fungicides and algicides, in an aqueous emulsion.

In particular, the mixture comprising siloxanes can be used in conjunction with at least one water-dissolved silane cocondensate as revealed by way of example in DE 15 18 551 A, EP 0 587 667 A, EP 0 716 127 A, EP 0 716 128 A, EP 0 832 911 A, EP 0 846 717 A, EP 0 846 716 A, EP 0 885 895 A, DE 198 23 390 A, or else DE 199 55 047 A, and/or with at least one if appropriate water-soluble fluoroorganic compound as revealed in U.S. Pat. No. 5,112,393, U.S. Pat. No. 3,354,022, or WO 92/06101, and/or with a water-emulsified silicone wax.

The substrates to be modified in the invention preferably have at least one HO group, MO group, and/or O⁻ group, and they generally have a large number of corresponding functional groups, being based on, or being, an organic material, an inorganic material, or a composite material, where M corresponds to an organic or inorganic cation. M can be a cation such as a metal cation or an organic cation. A modified substrate is preferably an Si-crosslinking system, an example being the formation of an Si—O-substrate bond or Si—O—Si-bond, for example between silanols and/or siloxanes, an example being the hydrolyzed organofunctionalized silane (III), the hydrolyzed silicon precursor compound of the formula IVa and/or IVb, a siloxane (formula I and/or II), silicates, silicas, or derivatives. The substrate used can comprise any of the functionalized substrates capable of condensation, in particular the abovementioned fillers, carrier materials, additives, pigments or flame-retardant compounds.

Substrates used preferably comprise inorganic oxidic compounds and/or compounds having hydroxy groups, examples being silicates, carbonates, such as calcium carbonate, gypsum, aluminates, zeolites, metals, metal alloys, oxidized and/or passivated metals and/or alloys, or organic substrates, examples being a polymer matrix, a polymer, in particular activated (corona-treated) polymers, such as PE or PP, or else polymers such as PE; PP, EVA, resin, such as epoxy resin, acrylate resin, phenolic resin, polyurethane in the form of polymer matrix, in each case filled or unfilled, in the form of compounded material or in the form of an intermediate product, of a molding, of granules, or pellets, and other examples are other substrates familiar to the person skilled in the art of conventional shape and/or in conventional particle size.

The substrates can be smooth, porous, rough, and/or particulate extending as far as complete structures, or can be structural elements, parts of buildings, or developments. However, non-exclusive examples of the substrates are powders, dusts, sands, fibers, laminae of inorganic or organic substrates, such as quartz, fumed or other silica, silicon-oxide-containing minerals, titanium oxides, and other oxygen-containing titanium minerals, aluminum oxide, and other aluminum-oxide-containing minerals, aluminum hydroxides, such as aluminum trihydroxide, magnesium oxide and magnesium-oxide-containing minerals, magnesium hydroxides, such as magnesium dihydroxide, calcium carbonate and calcium-carbonate-containing minerals, glass fibers, mineral-wool fibers, and also particular ceramic powders, such as silicon carbide, silicon nitride, boron carbide, boron nitride, aluminum nitride, tungsten carbide, metal or metal powder, in particular aluminum, magnesium, silicon, copper, iron, and also metal alloys, and carbon blacks.

A substrate in the invention can be a structural element, glass, quartz glass, or a flame retardant, in which connection reference is made to the entire disclosure of EP0 970985 and EP 955344, and the disclosure is incorporated into this application, or a filler, carrier material, stabilizer, additive, pigment, or added substance, and/or auxiliary. The substrate can likewise be organic, examples being textile, wood, paper, paperboard, leather, silk, and wool, and also natural, organic substrates, examples being vegetable fibers, such as linen, flax, silk, and cotton, and also other organic substrates known to the person skilled in the art, or inorganic substrates, such as granite, mortar, brick, concrete, screed, Yton, or gypsum, in particular in the form of structural element in the sector of buildings protection, and also other organic substrates known to the person skilled in the art. A structural element can be a portion of a building, of a structure, of an artwork or else can be synthetic stones, an example being synthetic marble, synthetic granite, or the like.

The carrier can be porous, particulate, or swellable or can, if appropriate, take the form of a foam. Particularly suitable carrier materials are polyolefins, such as PE, PP, EVA, or polymer blends, and suitable fillers are inorganic or mineral fillers, which can advantageously be reinforcing fillers, extending fillers, or else flame-retardant fillers. The carrier can moreover be in calcined, precipitated, and/or ground form. The carrier materials and fillers are specified in more detail hereinafter. By way of example, it is also possible to use a foamed glass as substrate. The carrier material can by way of example comprise wollastonite, kaolin, or else calcined, precipitated, or ground variants.

The following flame retardants are used with preference in the invention: ammonium orthophosphates, e.g. NH4H2PO4, (NH4)2HPO4, or a mixture of these (e.g. FR CROS™ 282, FABUTIT™ 747 S), ammonium diphosphates, e.g. NH4H3P2O7, (NH4)2H2P2O7, (NH4)3HP2O7, (NH4)₄P2O7, or a mixture thereof (e.g. FR CROS™ 134), ammonium polyphosphates, particularly but not exclusively those revealed in J. Am. Chem. Soc. 91, 62 (1969), e.g. those having crystal-structure phase 1 (e.g. FR CROS™ 480), with crystal-structure phase 2 (e.g. FR CROS™ 484), or a mixture of these (e.g. FR CROS™ 485), melamine orthophosphates, e.g. C3H6N6.H3PO4, 2 C3H6N6.H3PO4, 3 C3H6N6.2 H3PO4, C3H6N6.H3PO4, melamine diphosphates, e.g. C3H6N6.H4P2O7, 2 C3H6N6.H4P2O7 3 C3H6N6.H4P2O7 or 4 C3H6N6.H4P2O7, melamine polyphosphates, melamine borates, e.g. BUDIT™ 313, melamine cyanurate, e.g. BUDIT™ 315, melamine borophosphates, melamine 1,2-phthalates, melamine 1,3-phthalates, melamine 1,4-phthalates, and also melamine oxalates.

Fillers used preferably comprise inorganic or mineral materials. They can advantageously have reinforcing, extending, or else flame-retardant action. At least at their surfaces, they bear groups which can react with the alkoxy groups, or the hydroxy groups of the silanols, or of the unsaturated silane compound, or of the hydrolyzed compound of the siloxanes of the formula I and/or II. The result can thus be that the silicon atom having the functional group bonded thereto becomes chemically fixed on the surface. These groups on the surface of the filler are in particular hydroxy groups. Preferred fillers used are accordingly metal hydroxides having a stoichiometric proportion of hydroxy groups or, in their various stages of dehydration, having a substoichiometric proportion of hydroxy groups, extending as far as oxides having comparatively few residual hydroxy groups, where these are however detectable by DRIFT-IR spectroscopy or by NIR spectroscopy.

Fillers used with particular preference are aluminum trihydroxide (ATH), aluminum oxide hydroxide (AlOOH.aq), magnesium dihydroxide (MDH), brucite, huntite, hydromagnesite, mica, and montmorillonite. Other fillers that can be used are calcium carbonate, talc, and also glass fibers. It is moreover possible to use the materials known as “char formers”, examples being ammonium polyphosphate, stannates, borates, talc, or these in combination with other fillers. Surface-modified fillers of the invention are preferably aluminum hydroxide, magnesium hydroxide, chalk, dolomite, talc, kaolin, bentonite, montmorillonite, mica, silica, and also titanium dioxide.

Examples of stabilizer and/or further added substance and/or additives, or a mixture of these, that can be used are the following. The stabilizer and/or further added substances used can, if appropriate, comprise metal deactivators, processing aids, inorganic or organic pigments, or adhesion promoters. Examples of these are titanium dioxide (TiO₂), talc, clay, quartz, kaolin, aluminum hydroxide, magnesium hydroxide, bentonite, montmorillonite, mica (muscovite mica), calcium carbonate (chalk, dolomite), colored materials, talc, carbon black, SiO₂, precipitated silica, fumed silica, aluminum oxides, such as alpha and/or gamma-aluminum oxide, aluminum oxide hydroxides, boehmite, barite, barium sulfate, lime, silicates, aluminates, aluminum silicates, and/or ZnO, or a mixture of these. It is preferable that the added substances, such as pigments or additives, are in pulverulent, particulate, porous, or swellable form, or, if appropriate, take the form of foam.

As an alternative, the carrier material can be a nanoscale material. Preferred carrier materials, fillers, or added substances are aluminum hydroxide, magnesium hydroxide, fumed silica, precipitated silica, wollastonite, calcined variants, and chemically and/or physically modified materials, examples being kaolin and modified kaolin, and in particular ground, exfoliating materials, such as phyllosilicates, preferably specific kaolins, a calcium silicate, a wax, such as a polyolefin wax based on LDPE (“low-density polyethylene”), or a carbon black.

The carrier material can encapsulate the silicon-containing precursor compound and/or the organofunctional silane compound, or can retain it in physically or chemically bound form. It is advantageous here if the loaded or unloaded carrier material is swellable.

Preferred carrier materials that may be mentioned individually are: ATH (aluminum trihydroxide, Al(OH)₃), magnesium hydroxide (Mg(OH)₂), or fumed silica, which is produced on an industrial scale by continuous hydrolysis of silicon tetrachloride in a hydrogen/oxygen flame. The silicon tetrachloride here is evaporated and then reacts spontaneously and quantitatively within the flame with the water deriving from the oxygen/hydrogen reaction. Fumed silica is an amorphous form of silicon dioxide in the form of an uncompacted, bluish powder. The particle size is usually in the region of a few nanometers, and specific surface area is therefore large, generally being from 50 to 600 m²/g. The process by which the vinylalkoxysilanes and/or the silicon-containing precursor compound, or a mixture of these, become(s) attached here is in essence based on adsorption. Precipitated silicas are generally produced from sodium waterglass solutions, by neutralization with inorganic acids under controlled conditions. After isolation from the liquid phase, washing, and drying, the crude product is finely ground, e.g. in steam-jet mills. Again, precipitated silica is a substantially amorphous silicon dioxide, the specific surface area of which is generally from 50 to 150 m²/g. Unlike fumed silica, precipitated silica has a certain porosity, for example about 10% by volume. The process by which the vinylalkoxy-silanes and/or the silicon-containing precursor compound, or a mixture of these, become(s) attached can therefore be either adsorption on the surface or absorption within the pores. Calcium silicate is generally produced industrially by fusing quartz or kieselguhr with calcium carbonate or calcium oxide, or by precipitation of aqueous sodium metasilicate solutions with water-soluble calcium compounds. The carefully dried product is generally porous and can absorb up to five times the amount by weight of water or oils.

An equally preferable carrier material is a porous polymer selected from polypropylene, polyolefins, ethylene copolymer with low-carbon alkenes, ethylene-vinyl acetate copolymer, high-density polyethylene, low-density polyethylene, or linear low-density polyethylene, where the pore volume of the porous polymer can be from 30 to 90%, and it can in particular be used in granulated form or in pellet form.

Other suitable carrier materials are porous polyolefins, such as polyethylene (PE) or polypropylene (PP), or else copolymers, such as ethylene copolymers with low-carbon alkenes, such as propene, butene, hexene or octene, or ethylene-vinyl acetate (EVA), where these are produced by way of specific polymerization techniques and specific polymerization processes. The particle sizes are generally from 3 to <1 mm, and the porosity can be above 50% by volume, and the products are therefore suitably capable of absorbing in particular large amounts of carboxy compounds IVa and/or IVb, and/or of the silanes of the formula III, and/or of the siloxanes of the formula I and/or II, or a mixture of these, without losing their free-flow properties. The kit of the invention can comprise carrier materials loaded in this way.

Particularly suitable waxes are polyolefin waxes based on “low-density polyethylene” (LDPE), preferably branched, having long side chains. The melting point and freezing point is generally from 90 to 120° C. The waxes generally give good mixing with the carboxy compounds and/or organofunctional silanes, and/or with the organofunctional siloxanes, or a mixture of these, in a low-viscosity melt. The solidified mixture generally has sufficient hardness to be capable of granulation. In particular, the kit of the invention comprises this type of mixture, preferably granulated.

The various commercially available forms of carbon black are suitable by way of example for the production of black cable sheathing.

The following methods inter alia are available for the production of the modified substrates or substrates on carriers, for example in the form of dry liquids, for use in the kit of the invention, for example made of organofunctional silanes and/or of organofunctional siloxanes, and/or carboxy compounds, an example being organofunctional silanecarboxysilane, e.g. vinylsilane carboxylate of myristic acid or lauric acid, and carrier material, or else of vinylsilane stearate and carrier material, or of a tetracarboxysilane and vinylalkoxysilane with carrier material:

Spray drying is among the best-known methods. Alternative methods are explained in more detail hereinafter: mineral carriers or porous polymers are generally preheated, e.g. in an oven to 60° C., and charged to a cylindrical container, which has been flushed and filled with dry nitrogen. A silane and/or siloxane and/or a carboxy compound is generally then added, and the container is placed into a roller apparatus which rotates it for a period of about 30 minutes. After this time, the carrier substance and the liquid, high-viscosity or waxy silane, siloxane, and/or carboxy compound, for example carboxysilane, have generally formed flowable granules with a dry surface, and these are usefully stored under nitrogen in containers impermeable to light. As an alternative, the heated carrier substance can be charged to a mixer, e.g. a LÖDIGE plowshare mixer or a HENSCHEL propeller mixer, which has been flushed and filled with dry nitrogen. The mixer unit can then be operated, and the organofunctional silane and/or the organofunctional siloxane and/or carboxysilane, in particular of the formula IVa, or a mixture of these, can be sprayed into the system by way of a nozzle once maximum mixing performance has been achieved. Once addition has ended, homogenization generally continues for about 30 further minutes, and the product is then drawn off, e.g. by means of a pneumatic conveying system operated using dry nitrogen, into nitrogen-filled containers impermeable to light.

Wax/polyethylene wax in pelletized form with a melting point of from 90 to 120° C. or above can be melted in portions in a heatable vessel with stirrer, reflux condenser, and liquid-addition apparatus, and kept in the molten state. During the entire production process, dry nitrogen is suitably passed through the apparatus. By way of the liquid-addition apparatus it is possible to add, for example, the liquid propyl-carboxysilanes, vinylcarboxysilanes, propylsiloxanes, or a mixture, progressively into the melt, and to mix these with the wax by vigorous stirring. The melt is then generally discharged into molds for solidification, and the solidified product is granulated. As an alternative, the melt can be allowed to drop onto a cooled molding belt on which it solidifies in the form of user-friendly pastilles.

In one embodiment of the invention, surface-modified flame retardants are produced. Surprisingly, it has been found that surface-modified flame retardants are obtainable in a simple, cost-effective, and simultaneously environmentally compatible manner by applying an organofunctional silane, or a mixture of organofunctional silanes, or an oligomeric, organofunctional siloxane, or a mixture of oligomeric siloxanes, or a solvent-containing preparation based on monomeric organofunctional silanes, and/or on oligomeric, organofunctional siloxanes, or a preparation based on water-soluble organofunctional siloxanes, to a pulverulent flame retardant, and, during the coating process, keeping the flame retardant in motion in the presence of a carboxy compound to be used in the invention.

In a suitable method here, the coating composition is added dropwise directly into a fluidized bed of the flame retardant to be treated, or is injected through a nozzle or applied by spraying, where the coating composition generally reacts with the surface of the flame retardant and thus coats the particles. During this process, water of condensation and also, if appropriate, small amounts of alcohol can be produced via condensation or hydrolysis, and these are introduced in a manner known per se with the exhaust air from the process into an exhaust-air-cleaning system, e.g. a condensation system or a downstream catalytic or thermal combustion system.

The carboxy compounds of the invention particularly advantageously permit coating almost entirely without any medium, and this means that it is in essence possible to omit additional solvents, by virtue of the dispersibility or homogenizability of the carboxy compounds. Solvents that can be used are pentane, ethanol, methanol, xylene, toluene, THF, and ethyl acetate. A cost-effective and environmentally compatible method uses a preparation in the form of paste or solid based on organofunctional siloxanes and/or on organofunctional silanes. It is preferable to use small amounts of solvent or to add no solvent. It is moreover possible to use a system which is not explosion-protected. The present procedure does not moreover produce any filtration residues or any wash water.

The present invention therefore provides a process for modifying the surface of substrates, in particular of inorganic fillers, such as kaolin, TiO₂, and pigments, and the process of the invention is explained in more detail on the basis of a flame retardant, without restricting the process thereto. The process for modifying the surface of a substrate is described hereinafter on the basis of a flame retardant by coating the particles with a silicon-containing coating composition, where an organofunctional silane or a mixture of organofunctional silanes, or an oligomeric, organofunctional siloxane, or a mixture of at least two of the compounds, or a solvent-containing preparation based on monomeric organofunctional silanes and/or on oligomeric, organofunctional siloxanes, or a preparation based on siloxanes, is applied to a, in particular pulverulent, flame retardant, and the flame retardant is kept in motion during the coating process, in the presence of a carboxy compound of the invention, in particular in the form of silane hydrolysis catalyst and/or in the form of silanol condensation catalyst.

The amount of silicon-containing coating composition used in the process of the invention, based on the amount of flame retardant, is preferably from 0.05 to 10% by weight, particularly preferably from 0.1 to 3% by weight, with particular preference from 0.1 to 2.5% by weight, very particularly preferably from 0.5 to 1.5% by weight.

In particular, the coating composition is applied during the course of from 10 seconds to 2 hours at a temperature of from 0 to 200° C., preferably in the course of from 30 seconds to 10 minutes at a temperature of from 20 to 100° C., particularly preferably in the course of from 1 to 3 minutes at a temperature of from 30 to 80° C.

In a suitable method, in the process of the invention, the substrate coated with coating composition, in particular the filler or the flame retardant, is treated with exposure to heat or under reduced pressure, or under reduced pressure with simultaneous exposure to heat.

It is preferable that this type of posttreatment of the substrate coated with coating composition, in particular of the filler or flame retardant, takes place at a temperature of from 0 to 200° C., particularly at a temperature of from 80 to 150° C., very particularly at a temperature of from 90 to 120° C.

The process of the invention is suitably conducted in a stream of air or in a stream of inert gas, such as nitrogen or carbon dioxide.

In another possible method of carrying out the process of the invention, the coating process and, if appropriate, subsequent drying of the coated substrate, in particular of the filler or flame retardant, is/are repeated one or more times.

The process of the invention preferably uses substrates, in particular carrier materials, fillers, or flame retardants, with a median grain size (d50 value) of from 1 to 100 μm (micrometers), particularly from 2 to 25 μm, very particularly from 5 to 15 μm. This type of pulverulent flame retardant is suitably dry, i.e. flowable.

In the process of the invention, it is useful to employ a solvent-containing preparation which has less than 0.5% by weight content of an alcohol, based on the entire preparation, and the pH of which is from 2 to 6 or from 8 to 12.

Preference is given to use of the following organofunctional silanes for this purpose: aminoalkyl- or epoxyalkyl- or acryloxyalkyl- or methacryloxyalkyl- or mercaptoalkyl- or alkenyl- or alkyl-functional alkoxysilanes, where abovementioned hydrocarbon units suitably contain from 1 to 8 carbon atoms and the alkyl groups may take linear, branched, or cyclic form. Particularly preferred organofunctional alkoxysilanes are: 3-aminopropyltrialkoxysilanes, 3-aminopropylmethyldialkoxysilanes, cyclohexyl-aminopropyltrimethoxysilane, cyclohexylaminopropyltriethoxysilane, cyclohexyl-aminopropylmethyldimethoxysilane, cyclohexylaminopropylmethyldiethoxysilane, 3-glycidyloxypropyltrialkoxysilanes, 3-acryloxypropyltrialkoxysilanes, 3-meth-acryloxypropyltrialkoxysilanes, 3-mercaptopropyltrialkoxysilanes, 3-mercaptopropyl-methyldialkoxysilanes, vinyltrialkoxysilanes, vinyltris(2-methoxyethoxy)silane, propyl-trialkoxysilanes, butyltrialkoxysilanes, pentyltrialkoxysilanes, hexyltrialkoxysilanes, heptyltrialkoxysilanes, octyltrialkoxysilanes, propylmethyldialkoxysilanes, butylmethyl-dialkoxysilanes, and the alkoxy groups are in particular methoxy, ethoxy, or propoxy groups.

Oligomeric organofunctional siloxanes that can be used in the invention are those in particular revealed in EP 0 518 057 A1, and also DE 196 24 032 A1. The use preferably includes those which, as substituents, bear (i) alkyl and alkoxy groups, in particular linear, branched, or cyclic alkyl groups having from 1 to 24 carbon atoms, and alkoxy groups having from 1 to 3 carbon atoms, or (ii) vinyl and alkoxy groups and, if appropriate, alkyl groups, in particular alkoxy groups having from 1 to 3 carbon atoms and, if appropriate, linear, branched, or cyclic alkyl groups having from 1 to 24 carbon atoms, where said oligomeric organoalkoxysiloxanes preferably have a degree of oligomerization of from 2 to 50, particularly preferably from 3 to 20.

It is particularly preferable here to use oligomeric, vinyl-functional methoxysiloxanes, such as DYNASYLAN® 6490 or Protectosil® 166, or oligomeric, propyl-functional methoxysilanes, such as DYNASYLAN™ BSM 166.

In another suitable method, a solvent-containing preparation based on monomeric organofunctional alkoxysilanes and/or on oligomeric organofunctional alkoxysiloxanes can preferably be used, where this preferably comprises methanol, ethanol, n-propanol, isopropanol, and/or water as solvent. These solvent-containing preparations can also comprise emulsifiers.

The process of the invention can generally be carried out as follows:

The coating composition, which is generally liquid, can be introduced directly into a bed of pulverulent flame retardant, e.g. ammonium polyphosphate, where the bed has been fluidized by introducing a gas.

This process usually coats the particles of the flame retardant with coating composition, where the coating composition reacts with the surface of the flame retardant, and alcohol of hydrolysis and, respectively, water of condensation can be liberated.

The flame retardant thus treated is, if appropriate, after the application of the coating composition, in a subsequent mixing procedure, freed from residual adherent alcohol of hydrolysis and, respectively, water of condensation, e.g. by introducing dry warm air, and also reducing the pressure.

Whereas the coating processes known hitherto operate in an organic solvent, the process of the invention does not generally require any types of auxiliaries that are difficult to handle or that are particularly pollutant.

The present process can also include the following practical features:

Conversion of the flame retardant that requires coating to a fluidized bed in a suitable assembly. This can by way of example be a mixer running at relatively high speed, or any similar apparatus, where the pulverulent flame retardant introduced is suitably in continuous motion, and the individual particles have uninterrupted contact with one another. It is also possible to introduce a gas, e.g. air, nitrogen, or CO₂, into the assembly, where the gas has, if appropriate, been preheated. A heatable assembly can moreover be used.

Introduction of the coating composition with maximum uniformity of distribution into the fluidized material. This can be achieved by introduction through a nozzle or dropwise addition or spraying of the coating composition into the fluidized material.

The amount of the coating composition to be applied generally depends on the intended purpose of the flame retardant that requires coating, and mostly depends on the magnitude of the specific surface area of the flame retardant to be coated, and also on the amount of the flame retardant to be coated, where the ratio between the specific surface area of the flame retardant and the specific wetting area of the coating composition can be taken by way of example as a guideline value for a monomolecular coating.

Surface-modified flame retardants are not only obtainable in a simple, cost-effective, and environmentally compatible manner by the process of the invention but also, when compared with untreated flame retardants or with flame retardants treated with other coating compositions, have lower water-solubility and advantageous properties during further processing in polymer compositions, an example being the possibility of adding relatively large amounts of the flame retardant (fill level), greater ease of incorporation, and less effect on physical data.

The present invention likewise provides surface-modified flame retardants obtainable by the process of the invention.

The flame retardants surface-modified and stabilized by the process of the invention can be incorporated into many combustible polymers with particularly advantageous effect, for example into polyolefins, such as polyethylene, polypropylene, polystyrene, and its copolymers, examples being ABS and SAN, saturated or unsaturated polyesters, polyamides, and resins, such as epoxy resins, phenolic resins, acrylic resin, furan resins, polyurethanes, and also natural or synthetic rubbers.

However, flame retardants surface-modified in the invention can also be used advantageously for the intumescent coating of combustible materials.

It is also possible to render combustible natural materials, such as wood, particle board, or paper, flame-retardant or flameproof by using the flame retardants obtainable in the invention, or to provide them with an intumescent coating using a dispersion which comprises the flame retardants of the invention.

The absence of halogen in the flame retardants of the invention is also advantageous, and they therefore comply with the increasing requirements placed by the market on the environmental compatibility of the products produced therefrom.

The present invention therefore also provides the use of flame retardants of the invention in compounded polymer materials, and for providing flame retardancy to combustible natural materials.

The invention also provides a modified substrate, where the modified substrate, and in particular its exterior and/or interior surface, has been modified with at least one organofunctional silicon compound, and also, if appropriate, with at least one reaction product of an organofunctional carboxy compound. The modified substrate can be produced by analogy with the coating of the flame retardant described above. The flame retardant is then replaced by another substrate in the process.

Preference is also given to modification of the substrate per se, i.e. in bulk, for example when the actual production of the substrate uses the silanes, siloxanes, and carboxy compound. An example is the production of gypsum or gypsum board.

It is particularly preferable that the substrate has been modified with an organofunctional silicon compound of a reaction product of the reaction of at least one organofunctionalized silane, in particular of a silanol of the general formula III, preferably of an alkoxysilane of the formula III, and/or of at least one linear, branched, cyclic, and/or three-dimensionally crosslinked oligomeric organo-functionalized siloxane, in particular of the idealized general formulae I and/or II, in the presence of at least one organofunctional carboxy compound selected from the group of a silicon-containing precursor compound of an organic acid, in particular of the general formula IVa and/or IVb, of an organic acid, and/or of a silicon-free precursor compound of an organic acid.

It is preferable that the abovementioned silanes, siloxanes, organic acids, and/or silicon-containing precursor compounds of an organic acid are used in order to obtain the substrate modified in the invention. A modified substrate is a functionalized substrate, where the functionalization takes place by way of supramolecular interactions, in particular hydrogen bonds, and in the invention by way of covalent Si-O-substrate bonds or other covalent bridging between Si and the substrate, and in particular the organofunctional silicon compound has been covalently bonded to the substrate, and the reaction product of the organofunctional carboxy compound has been covalently and/or supramolecularly bonded to the substrate.

The substrate of the invention has been modified with an organofunctional silicon compound of a reaction product of the reaction a.1) of at least one alkoxysilane of the general formula III

(B)_{b}SiR⁴ₐ(OR⁵)^{4-b-a} (III)
where mutually independently b is 0, 1, 2, or 3 and a is 0, 1, 2, or 3, with the proviso that in formula III b+a is smaller than or equal to (≦) 3,
where B is mutually independently a monovalent organofunctional group in formula III, where B is as defined above,
R⁵ is mutually independently methyl, ethyl, n-propyl, and/or isopropyl,
R⁴ is mutually independently a substituted or unsubstituted carbon-containing group, in particular a hydrocarbon group, and/or
   a.2) of at least one linear, branched, cyclic, and/or three-dimensionally crosslinked oligomeric, organofunctionalized siloxane having noncyclic and/or cyclic structural elements, where the siloxanes are represented in idealized form by the two general formulae I and II, and the crosslinked structural elements can lead to three-dimensionally crosslinked siloxane oligomers,

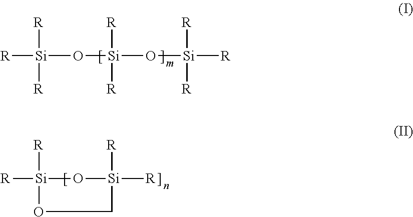

where the substituents R of the noncyclic, cyclic, and/or crosslinked structural elements are composed of organic moieties and/or of hydroxy groups, and the degree of oligomerization m for oligomers of the general formula I is in the range 0≦m<50, preferably 0≦m<30, particularly preferably 0≦m<20 and, for oligomers of the general formula II, n is in the range 2≦n≦50, preferably 2≦n≦30, where the definitions of the substituents R are as above, and/or
a.3) of a mixture of at least two of the abovementioned compounds of the formula I, II, and/or III, and/or their condensates and/or cocondensates and/or block cocondensates, or a mixture of these
in the presence of the substrate, and
in the presence of an organofunctional carboxy compound selected from the group of:
   b.1) a silicon-containing precursor compound of an organic acid of the general formula IVa,

(A)_{z}SiR²ₓ(OR¹)_{4-z-x} (IVa)

(R¹O)_{3-y-u}(R²)ᵤ(A)_{y}Si-A-Si(A)_{y}(R²)ᵤ(OR¹)_{3-y-u} (IVb)
where, mutually independently, z is 0, 1, 2, or 3, x is 0, 1, 2, or 3, y is 0, 1, 2, or 3 and u is 0, 1, 2, or 3, with the proviso that in formula IVa z+x is smaller than or equal to (≦) 3 and in formula IVb y+u is independently smaller than or equal to (≦) 2,
A is mutually independently in formula IVa and/or IVb a monovalent organofunctional group, and A in the form of divalent moiety in formula IVb is a divalent organofunctional group,
R¹ corresponds mutually independently to a carbonyl-R³ group, where R³ corresponds to a moiety having from 1 to 45 carbon atoms, in particular to a hydrocarbon moiety;
R² is mutually independently a hydrocarbon group, where the definitions of z, x, y, u, A, R², and R¹ are as above, and/or
   b.2) an organic acid selected from the group of
iii.a) a carboxylic acid comprising from 4 to 45 carbon atoms,
iii.b) a saturated and/or unsaturated fatty acid, and/or
iii.c) a natural or synthetic amino acid, and/or
   b.3) a silicon-free precursor compound of an organic acid, as example being an anhydride, ester, lactone, or salt of an organic cation, and in particular a natural or synthetic triglyceride, and/or phosphoglyceride, where the acids and/or precursor compounds correspond to the above definition, and/or.

In accordance with the statements above, the term modified means covalent and/or supramolecular bridging of the substrate to an organofunctional silicon compound and/or to a reaction product of an organofunctional carboxy compound, and in particular means the reaction product of a carboxy compound obtainable by reaction of the abovementioned carboxy compounds with the substrate.

The substrate of the invention has HO groups, MO groups, and/or O⁻ groups, and preferably has a large number of substrate-O-silicon-organofunctional compound, and is an organic material, an inorganic material, or a composite material. The substrate of the invention has been mentioned above, as also has the meaning of M.

The invention also provides a silane-terminated, in particular reduced-metal-content, preferably metal-free, polyurethane in the form of adhesive mass or sealant mass, where this polyurethane is based on the reaction of at least one aliphatic primary or secondary aminoalkoxysilane of the general formula VIa and/or VIb, in particular of the general formula VIa

(R⁶)_{n′}NH_{(2-n′)}(CH₂)_{m′}Si(R⁷)_{v′}(OR⁸)_{(3-v′)} VIa

or of one aliphatic primary or secondary aminoalkoxysilane of the general formula Vb,

(R⁶)_{n′}NH_{(2-n′)}CH₂CH(R⁷)CH₂Si(R⁷)_{v′}(OR⁸)_{(3-v′)} VIb,

in particular secondary aminoalkoxysilanes of the formulae VIa and/or VIb, where n′ is 1, where R⁶ in the formulae VIa and VIb represents a linear or branched alkyl group having from 1 to 18 carbon atoms, R⁷ is independently a methyl group, and R⁸ is independently a methyl, ethyl, or propyl group, v′ is 0 or 1, n′ is 0 or 1, and m′ is 0, 1, 2, or 3, and in particular m′ is 3, with a polyurethane prepolymer, or is obtainable in that manner,
where, in a further step, hydrolysis and/or condensation, in particular of the alkoxy groups or else, if appropriate, crosslinking of the polyurethanes, takes place in the presence of the carboxy compound in accordance with above definition, in particular in the form of silane hydrolysis catalyst and/or silanol condensation catalyst, and/or in the form of polyurethane crosslinking catalyst.

In the construction industry, joints serve to compensate movements between individual structural elements which by way of example result from thermal expansion or settling. The joints are generally sealed by using sealants, for example to DIN EN ISO 11600. Compensation for movements through elastic deformation is another requirement placed upon the sealants, alongside the sealing function. Polymers on which the production of said sealants is based comprise silicones, acrylates, butyl rubbers, polysulfides, polyurethanes, and MS polymers. Silane-crosslinking polyurethanes are novel for said application.

The reaction of primary, or preferably secondary, aminosilanes with isocyanate-containing polyurethane prepolymers leads to silane-terminated polyurethanes, where these can be crosslinked by means of moisture. The crosslinking of corresponding sealant masses and adhesive masses can be accelerated by addition of a catalyst. The carboxy compounds of the invention, for example the organic acid and/or the silicon-containing precursor compound of an organic acid, in particular of the formulae IVa and/or IVb, are corresponding catalysts which accelerate the crosslinking process.

Traditional isocyanate-containing polyurethane prepolymers are generally obtained from polyols, mostly composed of ethylene oxide and/or of propylene oxide, and from aliphatic or aromatic isocyanates.

It has been found that the reaction of aliphatic secondary aminosilanes of the general formula (VIa) or (VIb) with isocyanate-containing polyurethane prepolymers in the absence of a metal catalyst, in particular of a tin catalyst, leads to colorless and low-viscosity silane-terminated polyurethanes. No metal catalyst, e.g. dibutyltin dilaurate (DBTL), is necessary for the present silane-termination reaction. This is advantageous since in particular high content of tin compounds promotes the thermal cleavage of —NR—CO—NR groups.

In the invention, said silane-terminated polyurethanes are reacted with a carboxy compound as catalyst, in particular to give adhesive masses and sealant masses.

The low-viscosity, metal-free silane-terminated polyurethanes can be formulated in a simple and cost-effective manner with further additives, examples being fillers, plasticizers, agents having thixotropic effect, stabilizers, pigments, etc., to give adhesives and sealants.

The silane-terminated polyurethane sealant masses and adhesive masses produced in the invention are moreover particularly environmentally compatible since they are in essence free from residues of metal catalysts, i.e. are metal-free.

Preference is likewise given to the use of metal-containing crosslinking catalysts in the presence of carboxy compounds. It is preferable that the amounts used of the metal-containing crosslinking catalysts, such as dibutyltin, or other conventional crosslinking catalysts, in the presence of carboxy compounds, are below 0.06% by weight to 0% by weight, based on the total amount of the sealant mass. The amount of the metal-containing crosslinking catalyst can preferably be reduced, in the presence of a carboxy compound, in accordance with above definition, to below 0.01 to 0% by weight, particularly preferably to from 0.005 to 0% by weight, based on the entire sealant mass.

Another advantage in the production of silane-terminated polyurethanes is the rapid reaction of the isocyanate groups of the polyurethane prepolymer with a secondary aliphatic aminosilane of the general formula (VIa) or (VIb), preferably with DYNASYLAN® 1189 in accordance with the following reaction system:

prepolymer-NCO+nBu-NH—(CH₂)₃—Si(OMe)₃->prepolymer-NH—CO-nBuN-(CH₂)₃—Si(OMe)₃.

When secondary aminosilanes are used in the process, the possible, but undesired chain-extension side-reaction—undesired since it increases the viscosity—is not observed and is therefore effectively and therefore advantageously suppressed:

prepolymer-NH—CO-nBuN-(CH₂)₃—Si(OMe)₃+prepolymer-NCO->prepolymer-N(CO—NH-prepolymer)-CO-nBuN-(CH₂)₃—Si(OMe)₃

The present invention therefore provides metal-free, in particular tin-free, silane-terminated polyurethanes in the form of adhesive masses and sealant masses.

The present invention also provides a metal-free silane-terminated polyurethane which is obtainable through the reaction of at least one aliphatic secondary aminoalkylalkoxysilane of the general formula VIa, for example R″—NH—(CH₂)₃Si(R^{1′})ₓ(OR^{2′})₍₃₋ₓ₎ for n′=1 in (VIa), or of at least one aliphatic secondary aminoalkylalkoxysilane of the general formula (VIb): R″—NH—CH₂—CH(R^{1′})—CH₂—Si(R^{1′})ₓ(OR^{2′})₍₃₋ₓ₎, where n′=1 in (VIb), where R″ in the formulae (VIa) and (VIb) is a linear, branched, or cyclic (e.g. cyclohexyl) alkyl group having from 1 to 18 carbon atoms, preferably having from 1 to 6 carbon atoms, R^{1′} is a methyl group, and R^{2′} is a methyl or ethyl group, and x′ is 0 or 1, with a polyurethane prepolymer in the absence of a metal catalyst, where the polyurethane prepolymer bears at least one terminal isocyanate group,
where, in a further step, a crosslinking process takes place in the presence of the carboxy compound as defined above.

As an alternative, n′ can be 0 in the formulae (IVa) and/or (IVb), for a primary amine.

In particular, the reaction of an aliphatic secondary aminoalkylalkoxysilane with a polyurethane prepolymer is conducted in the absence of a tin catalyst. Tin catalyst used in the prior art here usually comprises dibutyltin dilaurate (DBTL) or any other dialkyltin dicarboxylate compound.

Secondary aminoalkylalkoxysilane used here preferably comprises N-(n-butyl)-3-aminopropyltrimethoxysilane, N-(n-butyl)-3-aminopropyltriethoxysilane, N-(n-butyl)-3-aminopropylmethyldimethoxysilane, N-(n-butyl)-3-aminopropylmethyldiethoxysilane, N-(n-butyl)-3-amino-2-methylpropyltrimethoxysilane, N-(n-butyl)-3-amino-2-methylpropyltriethoxysilane or N-(n-ethyl)-3-amino-2-methylpropyltrimethoxysilane.

The term polyurethane prepolymer generally means a reaction product of a diol, for example those known as polyether polyols, an example being a polyethylene oxide or polypropylene oxide having terminal hydroxy groups and a molar mass of from 200 to 2000 g/mol, or of a polyol, i.e. a polyether polyol or a polyester polyol, or a mixture of these, and of at least one diisocyanate. An excess of diisocyanate is generally used here, so that the polyurethane prepolymers contain terminal isocyanate (NCO) groups. The diol/polyol component of the polyurethane prepolymer can have either polyether structure with very variable molecular weight or polyester structure with very variable molecular weight.

Diisocyanates that can be used are suitably either aliphatic compounds, e.g. isophorone diisocyanate (IPDI), hexamethylene diisocyanate (HDI), or aromatic compounds, e.g. tolylene diisocyanate (TDI), and diphenylmethane diisocyanate (MDI).

Preference is further given to a polyurethane prepolymer based on an aliphatic diisocyanate, preferably isophorone diisocyanate (IPDI) or hexamethylene diisocyanate (HDI). For polyurethane prepolymers based on an aromatic diisocyanate, preference is given to diphenylmethane diisocyanate (MDI).

The present invention moreover provides the process for the production of an adhesive mass and sealant mass of a metal-free silane-terminated polyurethane, where at least one aliphatic primary and/or secondary aminoalkylalkoxysilane of the general formula (VIa) as defined above, or at least one aliphatic primary and/or secondary aminoalkylalkoxysilane of the general formula (VIb) as defined above, is reacted with a polyurethane prepolymer, in particular in the absence of a metal catalyst, where the polyurethane prepolymer bears at least one terminal isocyanate group, where, in a further step, a crosslinking process takes place in the presence of the carboxy compound as defined above.

The present invention further provides the use of carboxy compounds together with at least one primary and/or secondary aliphatic aminosilane of the general formula (VIa) or (VIb) for the production of a polyurethane adhesive mass and polyurethane sealant mass of the invention, in particular for adhesive applications and for sealant applications, where the mass is in particular metal-free, preferably tin-free.

The process is generally carried out as follows: to produce the prepolymer, by way of example, a diisocyanate can be admixed with an anhydrous mixture of polyetherdiol and polyethertriol at about 30 to 40° C.

The reaction is suitably conducted under nitrogen blanketing and with exclusion of water. The mixture is usually allowed to react at about 70° C. until constant isocyanate (NCO) content is achieved. NCO content is generally checked, i.e. analyzed, during the reaction. The reaction mixture can moreover comprise a diluent or solvent, where this is preferably inert, an example being toluene. A secondary aminosilane can then be added in accordance with the NCO content.

The reaction of the polyurethane prepolymer with the secondary aminosilane is preferably conducted at from 25 to 80° C., and it is preferable here to add an excess of from 5 to 25 mol % of the secondary aminosilane.

The mixture is suitably stirred at a temperature in the range from 60 to 75° C., in particular at about 70° C., until no further free NCO is detectable.

It is moreover possible to add, to the reaction mixture of the reaction of the invention, a “water scavenger”, an example being an organofunctional alkoxysilane, preferably vinyltrimethoxysilane or vinyltriethoxysilane.

The product is metal-catalyst-free, silane-terminated polyurethane which can be used advantageously in the presence of a carboxy compound, in particular of an organic acid, and/or of a silicon-containing precursor compound of an organic acid, for adhesive applications and for sealant applications.

Against this background, the viscosity of silane-terminated polyurethanes is preferably from 12 000 to 25 000 mPa s, particularly preferably from 15 000 to 20 000 mPa s, (viscosity values at 25° C. to DIN 53 015) prior to the crosslinking process.

Silane-terminated polyurethanes can therefore be used advantageously together with carboxy compounds for the production of preparations for adhesive applications and for sealant applications. The silane-terminated polyurethane can suitably be utilized as parent material here. For this, the polyurethane is usually used as initial charge and is then mixed with plasticizer. It is preferable that the filler is then incorporated, with subsequent devolatilization of the mass. This is generally then followed by addition of desiccants, adhesion promoters, and other additives. The mass is usually subjected to thorough mixing and, for example, drawn off into cartridges. The crosslinking process can take place in the presence of a carboxy compound.

Adhesives and sealants based on silane-terminated polyurethanes preferably also comprise the following components, other than the silane-terminated polyurethanes:

Fillers and/or pigments, plasticizers, desiccants, adhesion promoters, rheology additives, e.g. for producing thixotropic properties, stabilizers, and preservatives.

The present invention therefore also provides the use in particular of metal-free, silane-terminated polyurethanes in preparations for adhesive applications and for sealant applications, in the presence of carboxy compounds as defined above.

The invention also provides a kit comprising at least one organofunctionalized silane, in particular of the general formula III, and as defined above, and/or at least one linear, branched, cyclic, and/or three-dimensionally crosslinked oligomeric, organofunctionalized siloxane, and/or a mixture, in particular of the formulae I and/or II, as defined above, of these and/or their condensates, and at least one organofunctional carboxy compound, in particular a silicon-containing precursor compound of an organic acid, in particular of the formula IVa and/or IVb, and/or an organic acid, in particular a saturated and/or unsaturated fatty acid as stated above. In the invention, the silane, the siloxane, or a mixture of these have been formulated together with the carboxysilane or have been formulated separately. In the invention, the carboxy compound as defined above does not become active as catalyst, in the presence of moisture, until it is heat-treated.

Preferred kits comprise a diamino-functional alkoxysilane, an alkyl trimyristic acid silane, and a solvent and/or a secondary aminoalkoxysilane, alkyl trimyristic acid silane.

Another component of the kit of the invention can be a substrate mentioned above, in particular a filler, flame retardant, carrier material, pigment, additive, added substance, and/or auxiliary.

The invention also provides a process for producing a composition, in particular a modified substrate or item, comprising organofunctional silicon compounds and comprising a silane hydrolysis catalyst and/or silanol condensation catalyst and, if appropriate, comprising a solvent and also, if appropriate, comprising water, where at least one organofunctional silane as defined above and/or one linear, branched, cyclic, and/or three-dimensionally crosslinked oligomeric, organofunctional siloxane as defined above, and/or their mixtures, and/or their condensates are condensed and/or hydrolyzed in the presence of moisture in the presence of a carboxy compound, in particular

b.1) a silicon-containing precursor compound of an organic acid of the general formula IVa,

(A)_{z}SiR²ₓ(OR¹)_{4-z-x} (IVa)

(R¹O)_{3-y-u}(R²)ᵤ(A)_{y}Si-A-Si(A)_{y}(R²)ᵤ(OR¹)_{3-y-u} (IVb)
where, mutually independently, z is 0, 1, 2, or 3, x is 0, 1, 2, or 3, y is 0, 1, 2, or 3 and u is 0, 1, 2, or 3, with the proviso that in formula I z+x is smaller than or equal to (≦) 3 and in formula II y+u is independently smaller than or equal to (≦) 2,
A is mutually independently in formula IVa and/or IVb a monovalent organofunctional group, and A in the form of divalent moiety in formula IVb is a divalent organofunctional group,
R¹ corresponds mutually independently to a carbonyl-R³ group, where R³ corresponds to a moiety having from 1 to 45 carbon atoms,
R² is mutually independently a hydrocarbon group, and/or
   b.2) an organic acid selected from the group of
iii.a) a carboxylic acid comprising from 4 to 45 carbon atoms,
iii.b) a saturated and/or unsaturated fatty acid, and/or
iii.c) a natural or synthetic amino acid, and/or
   b.3) a silicon-free precursor compound of an organic acid,
in particular an anhydride, ester, lactone, or salt of an organic cation, and in particular a natural or synthetic triglyceride, and/or phosphoglyceride.

In one embodiment, a substrate is present during the hydrolysis process and/or condensation process. The composition comprising, if appropriate, the substrate can harden, in particular to give an item or a coating.

The substrate can in particular be inorganic, examples being gypsum, mortar, masonry, or concrete, or can be organic, preferably being a filler, flame retardant, carrier material, pigment, additive, added substance, and/or auxiliary.

The pH at which the process is conducted is generally from 1 to 12, preferably from 2 to 9, preferably from 2 to 6 or from 7 to 9.

Particularly suitable solvents are pentane, toluene, xylene, alcohols, such as ethanol, propanol, or methanol, ethers, such as THF or tert-butyl methyl ether, and also other solvents familiar to the person skilled in the art. The solvents can be used in pure form or else in a mixture with water. As an alternative, the solvent used can comprise water or a water-alcohol mixture.

It is particularly preferable that the process is conducted without separate addition of a solvent. The process is therefore particularly environmentally compatible and reduces amounts of solvent considerably. It is particularly preferable here if the hydrolysis process and/or condensation process in the composition takes place at elevated temperature using the ambient moisture or the moisture present in the composition.

The hydrolysis process and/or condensation process preferably takes place at from 20 to 120° C., particularly preferably at from 30 to 100° C.

There are various methods available for the production of modified substrates. These are what is known as the pretreatment method, the in-situ method, and the dry-silane method, and the procedure for producing modified substrates can generally be analogous with the process stated above for the coating of flame-retardant fillers.

The invention therefore also provides a composition, in particular a modified substrate or an item, obtainable by the above process, if appropriate after crosslinking and/or after hardening.

The invention also provides the silicon-containing precursor compound of an organic acid of the formula IVa and/or IVb as defined above, in particular where a silicon-containing precursor compound of an organic acid is not a terminal carboxysilane compound, and in the invention it is a compound of the general formula IVa,

(A)_{z}SiR²ₓ(OR¹)_{4-z-x} (IVa)

(R¹O)_{3-y-u}(R²)ᵤ(A)_{y}Si-A-Si(A)_{y}(R²)ᵤ(OR¹)_{3-y-u} (IVb)
where, mutually independently, z is 0, 1, 2, or 3, x is 0, 1, 2, or 3, y is 0, 1, 2, or 3 and u is 0, 1, 2, or 3, with the proviso that in formula IVa z+x is smaller than or equal to (≦) 3 and in formula IVb y+u is independently smaller than or equal to (≦)₂, where, in one embodiment, z is preferably 1 and can usefully also be 2 or 3, and in another preferred embodiment z is 0, for tetra-α-carboxysilanes, and, for corresponding compounds of the formula IVb, y and u can both be 0, for a bis(tris-α-carboxydisilane),
A is mutually independently in formula IVa and/or IVb a monovalent organofunctional group, and A in the form of divalent moiety in formula IVb is a divalent organofunctional group,
A, in the form of organofunctional group, can preferably mutually independently correspond in formula IVa and/or IVb to an alkyl-, alkenyl-, aryl-, epoxy-, dihydroxyalkyl-, aminoalkyl-, polyalkylglycolalkyl-, haloalkyl-, mercaptoalkyl-, sulfanalkyl-, ureidoalkyl-, and/or acryloxyalkyl-functional group, in particular to a linear, branched, and/or cyclic alkyl moiety having from 1 to 18 carbon atoms, and/or a linear, branched, and/or cyclic alkoxy, alkoxyalkyl, arylalkyl, aminoalkyl, haloalkyl, polyether, alkenyl, alkynyl, epoxy, methacryloxyalkyl, and/or acryloxyalkyl group having from 1 to 18 carbon atoms, and/or an aryl group having from 6 to 12 carbon atoms, and/or a ureidoalkyl, mercaptoalkyl, cyanoalkyl, and/or isocyanoalkyl group having from 1 to 18 carbon atoms, and A can in particular correspond to a polyether of the formulae H₃C—(O—CH₂—CH₂—)ₙO—CH₂—, H₃C—(O—CH₂—CH₂—CH₂—)ₙO—CH₂—, H₃C—(O—CH₂—CH₂—CH₂—CH₂—)ₙO—CH₂—, H₃C—(O—CH₂—CH₂—)ₙO—, H₃C—(O—CH₂—CH₂—CH₂—)ₙO— and/or H₃C—(O—CH₂—CH₂—CH₂—CH₂—)ₙO—, having a chain length n of from 1 to 300, in particular from 1 to 180, preferably from 1 to 100, and/or an isoalkyl group having from 1 to 18 carbon atoms, a cycloalkyl group having from 1 to 18 carbon atoms, a 3-methacryloxypropyl group, a 3-acryloxypropyl group, methoxy group, or ethoxy group, or propoxy groups, or a fluoroalkyl group, vinyl group, 3-glycidyloxypropyl group, and/or allyl group, and/or

A can also correspond to a:

1) monovalent olefin group, a particular example being —(R⁹)₂C═C(R⁹)-M*ₖ—, in which R⁹ are identical or different, and R⁹ is a hydrogen atom or a methyl group, or a phenyl group, the group M* represents a group from —CH₂—, —(CH₂)₂—, —(CH₂)₃—, —O(O)C(CH₂)₃— or —C(O)O—(CH₂)₃—, k is 0, or 1, examples being vinyl, allyl, 3-methacryloxypropyl, and/or acryloxypropyl, n-3-pentenyl, n-4-butenyl, or isoprenyl, 3-pentenyl, hexenyl, cyclohexenyl, terpenyl, squalanyl, squalenyl, polyterpenyl, betulaprenoxy, cis/trans-polyisoprenyl, or
comprises R⁸—F_{g}—[C(R⁸)—C(R⁸)═C(R⁸)═C(R⁸)]ᵣ—F_{g}—, in which R⁸ are identical or different and R⁶ is a hydrogen atom or an alkyl group having from 1 to 3 carbon atoms, or an aryl group, or an aralkyl group, preferably a methyl group or a phenyl group, groups F are identical or different, and F is a group from —CH₂—, —(CH₂)₂—, —(CH₂)₃—, —O(O)C(CH₂)₃—, or —C(O)O—(CH₂)₃—,
   r is from 1 to 100, in particular 1 or 2, and g is 0 or 1,
and, in formula IVb, A in the form of a divalent moiety can be an olefin moiety in formula IVb, examples being the corresponding alkenylenes, such as 2-pentenylene, 1,3-butadienylene, iso-3-butenylene, pentenylene, hexenylene, hexendienylene, cyclohexenylene, terpenylene, squalanylene, squalenylene, polyterpenylene, or cis/trans-polyisoprenylene, and/or
   2) an A can mutually independently both in IVa and in IVb be a monovalent amino-functional moiety or a divalent amino-functional moiety in IVb, and in particular A can correspond to an aminopropyl-functional group of the formula
   —(CH₂)₃—NH₂, —(CH₂)₃—NHR′, —(CH₂)₃—NH(CH₂)₂—NH₂ and/or —(CH₂)₃—NH(CH₂)₂—NH(CH₂)₂—NH₂, in which R′ is a linear, branched, or cyclic alkyl group having from 1 to 18 carbon atoms, or an aryl group having from 6 to 12 carbon atoms,
A can be a cycloalkylaminoalkyl moiety or cyclohexylaminoalkyl moiety, e.g. cyclohexylaminopropyl,
A can correspond to one of the following amino-functional groups of the general formula Va or Vb

R¹⁰_{h*}NH_{(2-h*)}[(CH₂)ₕ(NH)]ⱼ[(CH₂)ₗ(NH)]ₙ—(CH₂)ₖ— (Va)

in which 0≦h≦6; h*=0, 1 or 2, j=0, 1 or 2; 0≦l≦6; n=0, 1, or 2;
0≦k≦6 in Va, and R¹⁰ correspond to a benzyl, aryl, vinyl, or formyl moiety and/or to a linear, branched, and/or cyclic alkyl moiety having from 1 to 8 carbon atoms, and/or

[NH₂(CH₂)ₘ]₂N(CH₂)ₚ— (Vb)

where 0≦m≦6 and 0≦p≦6 in Vb.
A in VIb can correspond to a divalent bisamino-functional group of the formula VI,

—(CH₂)ᵢ—[NH(CH₂)_{f}]_{g}NH[(CH₂)_{f*}NH]_{g*}—(CH₂)_{i*}— (Vc)

where, in formula Vc, i, i*, f, f*, g, and g* are identical or different, where i and/or i*=from 0 to 8, f and/or f*=1, 2, or 3, and g and/or g*=0, 1, or 2, and
3) A can correspond to an epoxy moiety and/or ether moiety, in particular to a 3-glycidoxyalkyl, 3-glycidoxypropyl, epoxyalkyl, epoxycycloalkyl, epoxycyclohexyl, or polyalkylglycolalkyl moiety, or to a polyalkylglycol-3-propyl moiety, or to the corresponding ring-opened epoxides, which take the form of diols.
4) A can correspond to a haloalkyl moiety, an example being R⁸*—Y_{m*}—(CH₂)_{s*}—, where R⁸* corresponds to a mono-, oligo-, or perfluorinated alkyl moiety having from 1 to 9 carbon atoms, or to a mono-, oligo-, or perfluorinated aryl moiety, where moreover Y corresponds to a CH₂, O, aryl, or S moiety, and m*=0 or 1, and s*=0 or 2, and/or
5) A can correspond to a sulfanalkyl moiety, where the sulfanalkyl moiety corresponds to the general formula VII with —(CH₂)_{q*}—X—(CH₂)_{q*}—, where q*=1, 2, or 3, X═Sₚ, where the average of p corresponds to 2 or, respectively, 2.18 or to 4 or, respectively, 3.8, with from 2 to 12 sulfur atoms distributed within the chain, and/or
6) A can be a silane-terminated polyurethane prepolymer-NH—CO-nBuN-(CH₂)₃—.

The moiety R¹ in the formula IVa and/or IVb can mutually independently correspond to a carbonyl-R³ group, where R³ corresponds to a moiety having from 1 to 45 carbon atoms, in particular to a saturated or unsaturated hydrocarbon moiety (HC moiety), which can be an unsubstituted or substituted moiety, and

R¹ preferably corresponds in formula IVa and/or IVb, mutually independently, to a carbonyl-R³ group, i.e. to a —(CO)R³ group (—(C═O)—R³), so that —OR¹ is —O(CO)R³, where R³ corresponds to an unsubstituted or substituted hydrocarbon moiety (HC moiety), in particular having from 1 to 45 carbon atoms, preferably having from 4 to 45 carbon atoms, in particular having from 6 to 45 carbon atoms, preferably having from 6 to 22 carbon atoms, particularly preferably having from 6 to 14 carbon atoms, with preference having from 8 to 13 carbon atoms, and in particular to a linear, branched, and/or cyclic unsubstituted and/or substituted hydrocarbon moiety, particularly preferably to a hydrocarbon moiety of a natural or synthetic fatty acid, and R³ in R¹ is in particular mutually independently a saturated HC moiety with —CₙH₂ₙ₊₁, where n=4 to 45, examples being —C₄H₉, —C₅H₁₁, —C₆H₁₃, —C₇H₁₅, —C₈H₁₇, —C₉H₁₉, —C₁₀H₂₁, —C₁₁H₂₃, —C₁₂H₂₅, —C₁₃H₂₇, —C₁₄H₂₉, —C₁₅H₃₁, —C₁₆H₃₃, —C₁₇H₃₅, —C₁₈H₃₇, —C₁₉H₃₉, —C₂₀H₄₁, —C₂₁H₄₃, —C₂₂H₄₅, —C₂₃H₄₇, —C₂₄H₄₉, —C₂₅H₅₁, —C₂₆H₅₃, —C₂₇H₅₅, —C₂₈H₅₇, —C₂₉H₅₉, or else preferably an unsaturated HC moiety, for example —C₁₀H₁₉, —C₁₅H₂₉, —C₁₇H₃₃, —C₁₇H₃₃, —C₁₉H₃₇, —C₂₁H₄₁, —C₂₁H₄₁, —C₂₁H₄₁, —C₂₃H₄₅, —C₁₇H₃₁, —C₁₇H₂₉, —C₁₇H₂₉, —C₁₉H₃₁, —C₁₉H₂₉, —C₂₁H₃₃ and/or —C₂₁H₃₁. The relatively short-chain HC moieties R³, examples being —C₄H₉, —C₃H₇, —C₂H₅, —CH₃ (acetyl), and/or R³═H (formyl), can likewise be used in the composition. However, because the HC moieties have low hydrophobicity, the composition is generally based on compounds of the formula I and/or II in which R¹ is a carbonyl-R³ group, selected from the group R³ with an unsubstituted or substituted hydrocarbon moiety having from 4 to 45 carbon atoms, in particular having from 6 to 22 carbon atoms, preferably having from 8 to 22 carbon atoms, particularly preferably having from 6 to 14 carbon atoms, or with preference having from 8 to 13 carbon atoms.

R² in formula IVa and/or IVb is mutually independently a hydrocarbon group, in particular a substituted or unsubstituted linear, branched, and/or cyclic alkyl, alkenyl, alkylaryl, alkenylaryl, and/or aryl group having from 1 to 24 carbon atoms, preferably having from 1 to 18 carbon atoms; in particular having from 1 to 3 carbon atoms in the case of alkyl groups. Particularly suitable alkyl groups are ethyl, n-propyl, and/or isopropyl groups. Particularly suitable substituted hydrocarbons are halogenated hydrocarbons, examples being 3-halopropyl groups, e.g. 3-chloropropyl or 3-bromo-propyl groups, where these are, if appropriate, susceptible to nucleophilic substitution, or else are groups that can be used in PVC.

In IVa here, where x is 0 and z is 1 or 2 or, if appropriate, 3, A is not an alkyl moiety and is not a vinyl moiety where, respectively, k is 1. In IVa, if x is not 0, A is not an alkyl moiety or a vinyl moiety, and/or if z is 0 and x is 0 R³ preferably has from 4 to 22 carbon atoms, particularly preferably from 8 to 14 carbon atoms.

—OR¹ is preferably a myristyl moiety, A is in particular not a vinyl moiety and, if appropriate, not an olefin moiety and/or not an unsubstituted alkyl moiety, and x is preferably 0. Preferred carboxysilanes have, as functional group A, aminopropyl, aminoethylaminopropyl, aminoethylaminoethylaminopropyl, N-butylaminopropyl, N-ethylaminopropyl, cyclohexylaminopropyl, glycidoxypropyl, methacryloxypropyl, or perfluoroalkyl.

The carboxysilanes mentioned are produced by reaction of the halosilanes substituted with the corresponding organofunctional group A, if appropriate in a solvent, with the corresponding organic acids, in particular with the corresponding carboxylic acids.

(A)_{z}SiR²ₓ(Hal)_{4-z-x} (IVa*)

The production of the corresponding chlorosilanes is known to the person skilled in the art. Alternate available processes are transesterification processes or reactions with salts of the carboxylic acids.

The invention also provides the use of the modified substrate as claimed in any of claims 1 to 10 or in particular of the polyurethane as claimed in claim 11 for, or as, adhesives, sealant masses, polymer compositions, adhesive masses, colored materials, and/or lacquers.

The invention also provides the use of carboxy compounds, in particular of the formula IVa and/or IVb, and/or of an organic acid, together with at least one organofunctionalized silane, in particular of the formula III, and/or at least one linear, branched, cyclic, and/or three-dimensionally crosslinked oligomeric, organofunctionalized siloxane, in particular of the formula I and/or II, and/or mixtures of these in accordance with above definition for the treatment, modification, hydrophobicization, and/or oleophobicization of substrates, or for the provision of antifingerprint and/or antigraffiti properties to substrates, or in the form of adhesion promoter, or in the form of binder, or in the form of protection for buildings.

The invention also provides the use of at least one silicon-containing precursor compound of an organic acid in the production of items, in particular of moldings, preferably of cables, hoses, or pipes, particularly preferably of drinking-water pipes, or else of hoses in the medical-technology sector.

The present invention also provides the use of a silane and/or siloxane, in particular of an oligomeric mixture of n-propylethoxysiloxanes and of a carboxy compound of the invention for the treatment of substrate surfaces, in particular of smooth, porous, and/or particulate substrates, particularly preferably to provide inorganic surfaces with water-repellent properties (hydrophobicization), with oil-repellent properties (oleophobicization), or dirt-repellent properties, or with properties that resist colonization by organisms and/or resist corrosion. The oligomeric mixture can be used suitably for antigraffiti applications or in compositions, in particular in compositions for antigraffiti applications, in particular in compounds with fluoroorganic compounds and, respectively, fluoro-functional silanes or siloxanes.

In particular, silanes and/or siloxanes, and the carboxy compounds of the invention, preferably the oligomeric mixtures of the siloxanes of n-propylethoxysiloxanes with a carboxy compound, are suitable for the use for deep impregnation of construction materials or of structures, very particularly for mineral construction materials, such as concrete, calcarious sandstone, granite, lime, marble, perlite, clinker, brick, porous tiles, terracotta, natural stone, expanded concrete, fiber-reinforced cement, finished concrete components, mineral render, screed, and clay items, but also artificial stone, masonry, façades, roofs, and also structures, such as bridges, harbors, residential buildings, industrial buildings, and public buildings, examples being parking lots, railroad stations, or schools, and also finished components, such as railroad sleepers or L blocks, to mention just a few examples.

The resultant mixture of silanes and/or siloxanes with the carboxy compounds of the invention, preferably of siloxane oligomers, can also be used for hydrophobicization, or to render materials oil-repellent, dirt-repellent, and/or paint-repellent, or to render them resistant to colonization by organisms and/or resistant to corrosion, or to render them adhesive, and/or for the surface-modification of textiles, of leather, of cellulose products, and of starch products, and for the coating of glass fibers and of mineral fibers, or in the form of binders or in the form of addition to binders, or for the surface-modification of fillers, for improving the rheological properties of dispersions and emulsions, or in the form of adhesion promoter, for example to improve the adhesion of organic polymers on inorganic substrates, or in the form of release agent, or in the form of crosslinking agent, or in the form of added substances for paints and lacquers.

The resultant mixture of silanes and/or siloxanes with the carboxy compounds of the invention can suitably be used for antigraffiti applications or in compositions, in particular in compositions for antigraffiti applications, in particular in compounds with fluoroorganic compounds and, respectively, fluoro-functional silanes or siloxanes.

The present invention provides the use of a mixture of the invention comprising n-propylethoxysiloxanes and carboxy compound for the treatment of smooth, porous, and/or particulate substrates, examples being powders, dusts, sands, fibers, laminae of inorganic or organic substrates, such as quartz, fumed or other silica, silicon-oxide-containing minerals, titanium oxides, and other oxygen-containing titanium minerals, aluminum oxide, and other aluminum-oxide-containing minerals, aluminum hydroxides, such as aluminum trihydroxide, magnesium oxide and magnesium-oxide-containing minerals, magnesium hydroxides, such as magnesium dihydroxide, calcium carbonate and calcium-carbonate-containing minerals, kaolin, wollastonite, talc, silicates, phyllosilicates, and also their respective modified variants, i.e. calcined, ground kaolin etc.; glass fibers, mineral-wool fibers, and also particular ceramic powders, such as silicon carbide, silicon nitride, boron carbide, boron nitride, aluminum nitride, tungsten carbide, metal or metal powder, in particular aluminum, magnesium, silicon, copper, iron, and also metal alloys, and carbon blacks.

The examples hereinafter provide further explanation of the present invention.

### A) Production of Alkyl- or Alkenyltricarboxysilane, or Tetracarboxysilane

### GENERAL EXAMPLES

a) To produce organofunctional carboxysilanes of the general formula IVa and/or IVb, for example to produce an organofunctional tricarboxysilane, 1 mol of the silane is reacted with 3 mol, or an excess, of the organic monocarboxylic acid, directly or in an inert solvent, in particular at elevated temperature. To react amino-functional silanes it can be preferable to conduct the reaction with salts of the carboxylic acid, examples being magnesium salts, for example of stearic acid, lauric acid, or myristic acid, or to conduct a reaction with corresponding esters of the acids, with elimination of water. If appropriate, the amino groups have to be capped in advance with conventional protective groups. It is preferable to produce aminocarboxysilanes by the process described in g).
b) As an alternative, to produce an organofunctional tricarboxysilane, 1 mol of an organofunctional trichlorosilane can correspondingly be reacted with 3 mol, or an excess, of an organic monocarboxylic acid, directly or in an inert solvent. It is preferable that the reaction takes place at elevated temperature, for example up to the boiling point of the solvent, or around the melting point of the organic fatty acid or the organic acid.
c) To produce tetracarboxysilanes, 1 mol of tetrahalosilane, in particular tetrachloro-silane or tetrabromosilane, is reacted with 4 mol, or an excess, of at least one monocarboxylic acid, for example a fatty acid or fatty acid mixture. The reaction can take place directly via melting or in an inert solvent, preferably at elevated temperature.
d) To produce alkenyltricarboxysilane, 1 mol of an alkenyltrichlorosilane, or in general terms an alkenyltrihalosilane, is reacted with 3 mol, or an excess, of the organic monocarboxylic acid, directly or in an inert solvent, in particular at elevated temperature.
e) To produce an alkyltricarboxysilane, 1 mol of an alkyltrichlorosilane is correspondingly reacted with 3 mol, or an excess, of an organic monocarboxylic acid, directly or in an inert solvent. It is preferable that the reaction takes place at elevated temperature, for example up to the boiling point of the solvent, or around the melting point of the organic fatty acid or the organic acid.
f) To produce tetracarboxysilanes, 1 mol of tetrahalosilane, in particular tetrachloro-silane or tetrabromosilane, is reacted with 4 mol, or an excess, of at least one monocarboxylic acid, for example one fatty acid or fatty acid mixture. The reaction can take place directly via melting or in an inert solvent, preferably at elevated temperature.
g) To produce amino-functional carboxysilanes, the halopropyl- or haloalkylsilanes are first produced, an example being a chloropropyltricarboxysilane. Nucleophilic substitution of the halogen at the alkyl moiety can be used to produce the amino-carboxysilane in the presence of an aminoalkylsilane or of ammonia. It is also possible to produce the diaminoalkyl compounds of the carboxysilanes correspondingly.

### Example 1

### Production of Vinyltristearylsilane

Reaction of 1 mol of vinyltrichlorosilane with 3 mol of stearic acid in toluene as solvent: 50 g of stearic acid (50.1 g) were used as initial charge in a flask with 150.0 g of toluene. After slight heating the solid dissolves. Cooling gave an opaque, high-viscosity mass which, on renewed heating, again forms a clear liquid. The oil bath was set to 95° C. at the start of the experiment, and after a mixing time of about 20 min the mixture was a clear liquid. 9.01 g of vinyltrichlorosilane were then rapidly added dropwise with a pipette. About 10 min later, the mixture was a clear liquid, and the oil temperature was set to 150° C. After approximately 3 further hours after the start of the experiment, the mixture was cooled under inert gas. Work-up involved distillative removal of the toluene. This gave a white solid which when melted has an oily and yellowish appearance. The solid can be subjected to another treatment in the rotary evaporator for further purification, for example over a prolonged period (from 3 to 5 h) with an oil-bath temperature of about 90° C. and a vacuum <1 mbar. The solid was characterized as vinyltrichlorosilane by way of NMR (¹H, ¹³C, ²⁹Si).

### Example 2

### Production of Vinyltridecanoic Acid

Reaction of 1 mol of vinyltrichlorosilane with 3 mol of capric acid in toluene as solvent: 60.0 g of capric acid (decanoic acid) were used as initial charge with 143.6 g of toluene in a flask. The oil bath was set to 80° C. at the start of the experiment, and the vinyltrichlorosilane was slowly added dropwise (about 0.5 h for 19.1 g) while the temperature of the mixture was about 55° C. After about 45 min, the temperature of the oil was increased to 150° C. After a reaction time of about a further 2 h, the oil bath was switched off, but the stirring, the water-cooling, and the nitrogen blanketing were continued until cooling was complete. The clear liquid was transferred to a single-necked flask, and the toluene was drawn off in a rotary evaporator. The oil bath temperature was set to about 80° C. The vacuum was adjusted stepwise to <1 mbar. The product was a clear liquid. The liquid was characterized as vinyltricaprylsilane by way of NMR (¹H, ¹³C, ²⁹Si).

### Example 3

### Production of Hexadecyltricaprylsilane

Reaction of 1 mol of Dynasylan® 9016 (hexadecyltrichlorosilane) with 3 mol of capric acid in toluene as solvent: 73.1 g of capric acid (decanoic acid) were used as initial charge with 156.2 g of toluene in a flask. The oil bath was set to 95° C. at the start of the experiment, and 50.8 g of Dynasylan® 9016 were added dropwise over a period of about 25 minutes. After about 30 min, the temperature of the oil was increased to 150° C. The experiment was terminated after reflux for about 1.5 h. The toluene was drawn off from the clear liquid in a rotary evaporator. The oil bath temperature was set to about 80° C. The vacuum was adjusted stepwise to <1 mbar. The product was a yellow oily liquid with a slightly pungent odor. The liquid was characterized in essence as hexadecyltricaprylsilane by way of NMR (¹H, ¹³C, ²⁹Si).

### Example 4

### Production of Vinyltripalmitylsilane

Reaction of 1 mol of vinyltrichlorosilane with 3 mol of palmitic acid in toluene as solvent: 102.5 g of palmitic acid were used as initial charge with 157.0 g of toluene in a flask. The oil bath was set to 92° C. at the start of the experiment, and the 22.0 g of vinyltrichlorosilane were slowly added dropwise over a period of about 15 minutes. After about 70 min, the temperature of the oil was increased to 150° C. The mixture was heated at reflux for about 4 h, and then the toluene was removed by distillation. The oil bath temperature was adjusted to about 80° C., and the vacuum was adjusted stepwise to 2 mbar. Cooling of the product gave a white, remeltable solid. The solid was characterized as vinyltripalmitylsilane by way of NMR (¹H, ¹³C, ²⁹Si).

### Example 5

### Production of Chloropropyltripalmitylsilane

Reaction of 1 mol of CPTCS (chloropropyltrichlorosilane) with 3 mol of palmitic acid in toluene as solvent: 40.01 g of palmitic acid were used as initial charge in a three-necked flask, and the oil bath was heated. Once all of the palmitic acid had dissolved, 11.03 g of the CPTCS (99.89% purity (GC/TCD)) were added dropwise within a period of about 10 min. The temperature was finally increased to 130° C. After about 3.5 h no further gas activity was observed in an attached gas-washer bottle, and the synthesis was terminated. The toluene was removed in a rotary evaporator. At a subsequent juncture, the solid was remelted and stirred at an oil bath temperature of about 90° C. under a vacuum of <1 mbar. After about 4.5 h, no further gas bubbles were observed. The solid was characterized as chloropropyltripalmitylsilane by way of NMR (¹H, ¹³C, ²⁹Si).

### Example 6

### Production of Propyltrimyristylsilane

Reaction of 1 mol of PTCS (propyltrichlorosilane, 98.8% purity) with 3 mol of myristic acid in toluene as solvent. The reaction was analogous to that in the above examples. The reaction product was characterized as propyltrimyristylsilane.

### Example 7

### Production of Vinyltrimyristylsilane

Reaction of Dynasylan® VTC with myristic acid: 40.5 g of myristic acid and 130 g of toluene are used as initial charge in the reaction flask, and mixed and heated to about 60° C. 9.5 g of Dynasylan® VTC are added dropwise within a period of 15 min by means of a dropping funnel. The temperature in the flask increases by about 10° C. during addition. After addition, stirring is continued for 15 minutes, and then the temperature of the oil bath is increased to 150° C. During the continued stirring, gas evolution (HCL gas) can be observed. Stirring was continued until no further gas evolution was observed (gas discharge valve), and stirring was continued for 3 h. After cooling of the mixture, unreacted Dynasylan® VTC and toluene are removed by distillation at about 80° C. at reduced pressure (0.5 mbar). The product remaining in the reaction flask is stored overnight in the flask with N₂ blanketing and then discharged without further work-up. The product subsequently solidifies. About 44.27 g of crude product were obtained.

### Example 8

### Production of Propyltrimyristylsilane

Reaction of Dynasylan® PTCS with myristic acid: 40.5 g of myristic acid and 150 g of toluene are used as initial charge in the reaction flask, and mixed and heated to about 60° C. Dynasylan® PTCS is added dropwise within a period of 15 minutes by means of a dropping funnel. The temperature in the flask increases by about 10° C. during addition. After addition the temperature of the oil bath is increased to 150° C. and stirring is continued for 3 h. During the continued stirring, gas evolution, HCL gas, can be observed. Stirring was continued until no further gas evolution was observed at the gas discharge valve. After cooling of the mixture, unreacted Dynasylan® PTCS and toluene are removed by distillation at about 80° C. at reduced pressure (0.5 mbar). The product is stored under inert gas and solidified. About 44.0 g of crude product were obtained.

### Example 9

### Production of Vinyltristearyl

For this, 1 mol of vinyltrichlorosilane was reacted with 3 mol of magnesium stearate:

7.8 g of vinyltrichlorosilane,
43 g of magnesium stearate
150 g of toluene (I349426710, Merck)

The magnesium stearate and the toluene were used as initial charge. The vinyltrichlorosilane was rapidly added dropwise with a pipette in two stages, with continuous stirring. This gave a white suspension. After a certain mixing time (a few minutes) the suspension was heated to about 100° C. with continuous stirring (magnetic stirrer). The vapor phase within the flask was analyzed with a pH paper. The vapor phase was strongly acidic. The oil bath was left at 100° C. for approximately 10 further hours, and continuous stirring was continued at this temperature. Oil-bath temperature was then increased to 150° C. The vapor phase remains strongly acidic. The experiment was terminated after approximately 6 further hours. The liquid in the glass flask was filtered with the aid of a folding filter and charged to a single-necked flask. The solid on the folding filter is insoluble in water.

A few days later, the contents of the single-necked flask were clear, and there were fine deposits at the bottom. The contents of the flask were first separated from the solid by pressure filtration (nitrogen), and the toluene was finally removed by distillation by way of a rotary evaporator. The resultant solid was brownish white and crystalline. The melting point was in the range from 150 to 160° C. The melt was viscous. NMR was used for characterization.

### Example 10

### Production of Carboxysilanes by Transesterification

### Example 10.1

### Reaction of 1 Mol of Vinyltrimethoxysilane with 5 Mol of Myristic Acid

1 mol of vinyltrimethoxysilane was reacted with 5 mol of myristic acid with n-heptane as entrainer.

The experimental apparatus used comprised a four-necked flask and a Vigreux column, and a water-cooled distillation head with manually adjustable reflux ratio (magnetic stirrer, oil bath, N₂ blanketing). n-Heptane was used as initial charge. The myristic acid was then added, and the vinyltrimethoxysilane was finally added. The oil bath was set to 125° C. Once reflux had become established at the top of the column, a start was made with removal of a very small amount of the distillate (fraction 1). Two phases formed. The take-off ratio was set for a few hours in such a way that there was no excessive increase in the overhead temperature. The worked-up transesterification product is a slightly yellowish solid. NMR analyses characterized the resultant product as mostly vinyl trimyristinate.

### Example 10.2

### Transesterification of 1 Mol of Vinyltrimethoxysilane with 5 Mol of Myristic Acid with n-Heptane as Entrainer, Using Water Separator

For this batch, a simple distillation bridge with a downstream water separator was used alongside the four-necked flask and a Vigreux column. (Magnetic stirrer, oil bath, and N₂ blanketing.) To prevent vapor from passing into the water separator by way of the reflux connection, a small water condenser was installed, which condensed the vapor at this point and thus forced the vapor to escape only by way of the Vigreux column. The myristic acid (tetradecanoic acid) was added first, then the n-heptane, and finally the vinyltrimethoxysilane. The oil bath was set to 155° C. After a certain time, an equilibrium became established and the vapor phase condensed and dripped into the water separator. Two phases formed immediately. After a few hours the water separator was full to the extent that the upper phase overflowed. The liquid was allowed to flow back into the material at the bottom of the column. When, towards the end of the transesterification process, the overhead temperature continued to fall, the oil-bath temperature was increased to 165° C. Constant reflux is obtained. Prior to the distillation process, it was observed that the contents of the flask were a clear liquid. The n-heptane was easily removed in the distillation process. After a certain time during which the temperature of the material at the bottom of the column was in the region of the boiling point of vinyltrimethoxy-silane (about 123° C. at atmospheric pressure) and the overhead temperature continued to fall (very little residual take-off), the distillation process was terminated. The worked-up transesterification product is a slightly yellowish solid comprising some internal liquid, and can be remelted by heating.

NMR analyses characterized the resultant product as mostly vinyl trimyristinate.

A) The sol-gel coating systems are produced in a sealed laboratory-scale round-bottomed glass flask with metering equipment and stirrer.

### Example 11

### Sol-Gel System Made of Methyltrimethoxysilane and Phenyltrimethoxysilane

563 g of methyltrimethoxysilane,
41 g of phenyltrimethoxysilane,
50 g of isopropanol,
100 g of methoxypropanol,
62 g of water,
5 g of myristic acid.

Solvent, acid, and water are used as initial charge. The silanes are mixed and metered into the acid-water-solvent mixture, with stirring. Within a few minutes, the solution becomes clear, and it is stirred for about 30 more minutes. This solution can be used for a number of days. Application to aluminum, using a doctor, gives flexible, transparent coatings of thickness from 0.5 to 15 μm. Hardening is best achieved at elevated temperature (e.g. 5 minutes at 200° C.).

### Example 12

### Sol-Gel System Made of Methyltriethoxysilane and Phenyltriethoxysilane

737 g of methyltriethoxysilane,
50 g of phenyltriethoxysilane,
50 g of isopropanol,
100 g of methoxypropanol,
62 g of water,
5 g of capric acid.

Solvent, acid, and water are used as initial charge. The silanes are mixed and metered into the acid-water-solvent mixture, with stirring. Within a few minutes, the solution becomes clear, and it is stirred for about 30 more minutes. This solution can be used for a number of days. Application to aluminum, using a doctor, gives flexible, transparent coatings of thickness from 0.5 to 15 μm. Hardening is best achieved at elevated temperature (e.g. 5 minutes at 200° C.).

### Example 13

### Sol-Gel System Made of Glycidyloxypropyltrimethoxysilane and Tridecafluorooctyltrimethoxysilane

225 g of 3-glycidyloxypropyltrimethoxysilane,
25 g of tridecafluoro-1,1,2,2-tetrahydrooctyltrimethoxysilane (also abbreviated to tridecafluorooctyltrimethoxysilane),
442 g of isopropanol,
265 g of water,
5 g of capric acid.

Solvent, acid, and water are used as initial charge. The silanes are mixed and metered into the acid-water-solvent mixture, with stirring. Within 24 h, the solution becomes clear, and it is stirred for about 24 more hours. This solution can be used for a number of months. Application to aluminum, using a doctor, gives flexible, transparent coatings of thickness from 0.5 to 15 μm with a marked repellency effect with respect to liquids applied (contact angle >90°). Hardening is best achieved at elevated temperature (e.g. 10 minutes at 200° C.).

### Example 14

### Sol-Gel System Made of Glycidyloxypropyltriethoxysilane and Tridecafluorooctyltriethoxysilane

265 g of 3-glycidyloxypropyltriethoxysilane,
27 g of tridecafluorooctyltriethoxysilane,
442 g of isopropanol,
265 g of water,
5 g of capric acid.

Solvent, acid, and water are used as initial charge. The silanes are mixed and metered into the acid-water-solvent mixture, with stirring. Within 24 h, the solution becomes clear, and it is stirred for about 24 more hours. This solution can be used for a number of months. Application to aluminum, using a doctor, gives flexible, transparent coatings of thickness from 0.5 to 15 μm with a marked repellency effect with respect to liquids applied (contact angle >90°). Hardening is best achieved at elevated temperature (e.g. 10 minutes at 200° C.).

### Example 15

### Sol-Gel System Made of Glycidyloxypropyltrimethoxysilane, Methyltrimethoxy-Silane and Tetramethoxysilane

229 g of methyltrimethoxysilane,
255 g of 3-glycidyloxypropyltrimethoxysilane,
73 g of tetramethoxysilane,
224 g of methoxypropanol,
75 g of water,
5 g of stearic acid.

Solvent, acid, and water are used as initial charge. The silanes are mixed and metered into the acid-water-solvent mixture, with stirring. Within a few minutes, the solution becomes clear, and it is stirred for about 10 more minutes. This solution can be used for a number of days. Application to aluminum, using a doctor, gives flexible, transparent coatings of thickness from 0.5 to 15 μm. Hardening is best achieved at elevated temperature (e.g. 10 minutes at 200° C.).

### Example 16

### Sol-Gel System Made of Glycidyloxypropyltriethoxysilane, Methyltriethoxysilane and Tetraethoxysilane

300 g of methyltriethoxysilane,
300 g of 3-glycidyloxypropyltriethoxysilane,
100 g of tetraethoxysilane,
224 g of methoxypropanol,
75 g of water,
5 g of palmitic acid.

Solvent, acid, and water are used as initial charge. The silanes are mixed and metered into the acid-water-solvent mixture, with stirring. Within a few minutes, the solution becomes clear, and it is stirred for about 30 more minutes. This solution can be used for a number of days. Application to aluminum, using a doctor, gives flexible, transparent coatings of thickness from 0.5 to 15 μm. Hardening is best achieved at elevated temperature (e.g. 15 minutes at 200° C.).

### B) Filler Treatment in the Presence of Long-Chain Fatty Acids

### Example 17

### Aluminum Trihydroxide

Treatment of ATH with 1% by Weight of Alkylsilane Oligomer Dynasylan® 9896 and, Respectively, Alkylsilane Dynasylan® OCTEO
Apparatus: Lödige mixer (heatable, vacuum drying), oil bath: from 70 to 80° C.
Amount of filler used: 1500 g

First, the filler is charged to the heated mixing chamber (about 60° C.), and the mixing procedure is started. The temperature measured in the chamber first falls to below 50° C. As soon as the temperature rises above 50° C., the rotation rate is reduced, and the silane is added to the mixer (injection/dropwise addition onto filler). Care has to be taken that the silane always comes into contact only with the filler. The rotation rate is then slowly adjusted to about 200 rpm, and the mixture is mixed for 20 minutes. Once the 20 minutes have expired, a vacuum is applied (about 400 mbar), and prior to application of the vacuum here the rotation rate is reduced to about 50 rpm; it is slowly again increased to 200 rpm only after the desired reduced pressure has been reached. After 60 minutes of drying time, the filler is removed from the mixer.

### Example 18

### Aluminum Trihydroxide

Treatment of ATH with 1% by Weight of Silanes (Alkylsilane Oligomer Dynasylan® 9896 and, Respectively, Alkylsilane Dynasylan® OCTEO with Additional 1% by Weight of Stearic Acid, Based on the Silane)
Apparatus: Lödige mixer (heatable, vacuum drying), oil bath: from 70 to 80° C.
Amount of filler used: 1500 g

First, the filler is charged to the heated mixing chamber (about 60° C.), and the mixing procedure is started. The temperature measured in the chamber first falls to below 50° C. As soon as the temperature rises above 50° C., the rotation rate is reduced, and the silane is added to the mixer (injection/dropwise addition onto filler). Care has to be taken that the silane always comes into contact only with the filler. The rotation rate is then slowly adjusted to about 200 rpm, and the mixture is mixed for 15 minutes. Once the 15 minutes have expired, a vacuum is applied (about 400 mbar), and prior to application of the vacuum here the rotation rate is reduced to about 50 rpm; it is slowly again increased to 200 rpm only after the desired reduced pressure has been reached. After 40 minutes of drying time, the filler is removed from the mixer.

### Efficiency Tests:

### —Flotation Test

Water is charged to two glass beakers. A spatula-tip specimen of the untreated and of the treated filler is placed on each water surface, and a stopwatch is used to measure the time before the filler sinks.

### —Percolation Test

Heaps of the respective treated and untreated specimen are placed next to one another, and a water droplet from 1 ml of water is placed on the respective heap. The time expired before the water droplet has percolated down into the material is determined.

Equally good results were found from the silane treatment in the presence of stearic acid after a relatively short reaction time and the treatment without fatty acid after a markedly longer time.

### Example 19

### Filler Treatment with Silane in a Primax Mixer

TiO₂ (Kronos® 2081) is used as initial charge in the stainless-steel container of the Primax mixer. The silane is added dropwise in portions of respectively from 1 to 2 ml onto the filler. During the dropwise addition process, the mixer is allowed to mix at slow setting (scale point 1). Between silane addition, mixing is respectively continued for about 1 minute at scale point 1. Once all of the silane has been added, mixing is continued for 15 minutes at scale point 2.5. The filler is placed on a stainless-steel sheet and finally dried for at least 3.5 h at 80° C.

### Example 20

### Filler Treatment with Silane in the Presence of Palmitic Acid

TiO₂ (Kronos® 2081) is used as initial charge in the stainless-steel container of the Primax mixer. The silane, comprising 1% by weight of palmitic acid, based on the silane, is added dropwise in portions of respectively from 1 to 2 ml onto the filler. During the dropwise addition process, the mixer is allowed to mix at slow setting (scale point 1). Between silane addition, mixing is respectively continued for about 1 minute at scale point 1. Once all of the silane has been added, mixing is continued for 15 minutes at scale point 2.5. The filler is placed on a stainless-steel sheet and finally dried for at least 2.5 h at 80° C.

### Efficiency Test: Stability of Aqueous Dispersion

100 ml of water are placed in a glass beaker, and 5 g of treated filler are added. The resultant dispersion is observed to see whether particles settle.

Equally good results were found from the silane treatment in the presence of stearic acid after a relatively short reaction time and the treatment without fatty acid after a markedly longer time.

### C) Sealant Production:

C.1) The following carboxy compounds: behenic acid, myristic acid, propylsilane trimyristate, and also vinylsilane trimyristate, were dissolved to give a 10% strength by weight solution in diisoundecyl phthalate (DIDP) at 50° C. To produce silane-terminated polyurethane sealant masses, propylsilane trimyristate and vinylsilane trimyristate were respectively added to a silane-terminated polyurethane.

100 g of the respective sealant masses were produced in a high-speed mixer, and the comparative formulation here comprised 0.006% of dibutyltin diacetylacetonate, and the amount added of the two silane tricarboxylates was respectively 1% by weight of the 10% strength by weight solution in DIDP. This corresponded to addition of 0.1% by weight of pure carboxylate. The plasticizer content of the carboxylate solution was subtracted from the total amount of plasticizer.

### Testing of Sealant Masses

The freshly produced sealant mass was charged to a hardening wedge, and a small amount is applied to paperboard, and serves to determine skinning of the sealant mass.

### Skinning

The tin-catalyzed specimen forms a skin after 1 hour, with no residual stringing observable. The masses comprising tricarboxysilane still exhibit stringing at that time. Another test after 24 hours showed residual tack for the tricarboxysilane-catalyzed sealant masses. The findings are similar for the hardening wedges.

### Bulk Hardening

With the tricarboxysilanes, in comparison with the tin-catalyst system, there is merely some initial delay in the bulk hardening of the sealant masses. After 2 days, bulk hardening has proceeded to 4 mm in the tricarboxysilane-catalyzed sealant masses and to 5 mm in the case of the tin-catalyzed system. After 7 days, bulk hardening has proceeded to 10 mm in both specimens.

C.2) SPU sealant mass production with the acids and, respectively, “carboxysilanes” Only PT- and, respectively, VT-myristic acid were used together with dibutyltin diacetylacetonate in our standard SPU formulation. 100 g of the masses were respectively produced in the high-speed mixer, where now 0.006% of dibutyltin diacetylacetonate comprised and respectively 1% of the 10% strength solution of the two carboxylates in DIDP was added. The latter corresponds to an addition of 0.1% of pure carboxylate. The plasticizer content of the carboxylate solution was subtracted from the total amount of plasticizer.

Hardening values and pot-life values thus obtained are analogous to those obtained with pure tin cat, but with the advantage of the significantly reduced amount of tin cat, and the resultant lower metal content and, respectively, reduced toxicity.

### B) Protection of Buildings—Bulk Hydrophobicization of Gypsum Plaster

For this, the formulations listed below were dispersed in water and then applied. After setting, the specimens were removed from the shell and dried for about 8 hours in a dryer at 40° C. The specimens were then dried for one week at room temperature and tested. The requirements placed upon gypsum plasterboard and impregnated gypsum plasterboard are defined in DIN EN 520 (valid since September 2005—fire performance of gypsum plasterboard). Water absorption after two hours of underwater storage has to be smaller than 10% by weight.

Formulations:

1. 30% by weight of IBTEO (isobutyltriethoxysilane)+30% by weight of Dynasylan A+1% by weight of stearic acid+39% by weight of ethanol

2. 30% by weight of IBTEO (isobutyltriethoxysilane)+30% by weight of Dynasylan A+3% by weight of stearic acid+37% by weight of ethanol

3. 30% by weight of 266 (propyltriethoxysilane oligomer)+30% by weight of Dynasylan A+1% by weight of stearic acid+39% by weight of ethanol

4. 30% by weight of IBTEO (isobutyltriethoxysilane)+30% by weight of Dynasylan A+3% by weight of palmitic acid+39% by weight of ethanol

5. Stearic acid and HS 2909 in a ratio of 1:2, where HS 2909 is a 20% by weight solution; (HS2909: aminoalkyl-functional co-oligomer)

The amounts of the formulations added to the gypsum plaster were as follows: formulations 1, 3 and 4 respectively 2% by weight, formulation 2 3% by weight, and formulation 5 1% by weight.

The formulations mentioned reduced the water absorption of the gypsum plaster by about 5% by weight in comparison with an untreated specimen.

1. A method of catalyzing at least one selected from the group consisting of a silane hydrolysis and a silanol condensation, the method comprising:
contacting at least one selected from the group consisting a silane and a silanol with at least one organofunctional carboxy compound in at least one form selected from the group consisting of a silane hydrolysis catalyst and a silanol condensation catalyst, wherein
the carboxy compound is an organic acid or a silicon-comprising precursor compound of an organic acid, or a silicon-free precursor compound of an organic acid.

2. A method of modifying a surface of a substrate, the method comprising:
contacting at least one organofunctional carboxy compound with the surface of the substrate, wherein
the carboxy compound is an organic acid, or a silicon-comprising precursor compound of an organic acid, or a silicon-free precursor compound of an organic acid.

3. The method of claim 1, wherein
the at least one organofunctional carboxy compound is at least one selected from the group consisting of:
b.1) a silicon-comprising precursor compound of an organic acid of formula (IVa) or (IVb),
(A)_{z}SiR²ₓ(OR¹)_{4-z-x} (IVa)
(R¹O)_{3-y-u}(R²)ᵤ(A)_{y}Si-A-Si(A)_{y}(R²)ᵤ(OR¹)_{3-y-u} (IVb),
wherein,
mutually independently, z is 0, 1, 2, or 3, x is 0, 1, 2, or 3, y is 0, 1, 2, or 3, and u is 0, 1, 2, or 3, with the proviso that in formula (Iva), z+x is smaller than or equal to (≦) 3 and, in formula (IVb), y+u is independently smaller than or equal to (≦) 2,
A is mutually independently in formula (Iva) and/or (IVb) a monovalent organofunctional group, and A in the form of divalent moiety in formula (IVb) is a divalent organofunctional group,
R¹ is mutually independently a carbonyl-R³ group, where R³ corresponds to a moiety having from 1 to 45 carbon atoms,
R² is mutually independently a hydrocarbon group;
b.2) an organic acid selected from the group consisting of
iii.a) a carboxylic acid comprising from 4 to 45 carbon atoms,
iii.b) a saturated fatty acid, an unsaturated fatty acid,
iii.c) a natural amino acid, and a synthetic amino acid; and
b.3) a silicon-free precursor compound of an organic acid,
wherein the at least one organofunctional carboxy compound, in the presence of at least one selected from the group consisting of an organofunctionalized silane, a linear, branched, cyclic, and/or three-dimensionally crosslinked oligomeric organofunctionalized siloxane, and a condensate thereof, acts as at least one selected from the group consisting of a silane hydrolysis catalyst and a silanol condensation catalyst.

4. The method of claim 3, wherein
a.1) the organofunctionalized silane is an alkoxysilane of formula (III),
(B)_{b}SiR⁴ₐ(OR⁵)_{4-b-a} (III),
wherein
mutually independently b is 0, 1, 2, or 3 and a is 0, 1, 2, or 3, with the proviso that in formula (III), b+a is smaller than or equal to (≦) 3,
B is mutually independently a monovalent organofunctional group,
R⁵ is mutually independently methyl, ethyl, n-propyl, or isopropyl,
R⁴ is mutually independently a substituted or unsubstituted hydrocarbon group, and/or
a.2) the linear, branched, cyclic, and/or three-dimensionally crosslinked oligomeric, organofunctionalized siloxane is present and comprises noncyclic and/or cyclic structural elements and is represented in idealized form by formulae (I) or (II), where crosslinked structural elements can lead to three-dimensionally crosslinked siloxane oligomers, 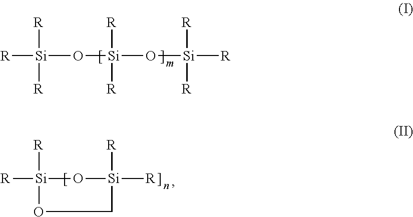
wherein the substituents R of the noncyclic, cyclic, and/or crosslinked structural elements are organic moieties and/or hydroxy groups, and a degree of oligomerization m for oligomers of formula (I) is in a range 0≦m<50, and, for oligomers of formula (II), n is in a range 2≦n≦50, and/or
a.3) the organofunctionalized silane is a mixture of at least two of the compounds of formulae (I), (II), and/or (III), and/or
a.4) the organofunctionalized silane is a mixture in the form of reaction product of at least two of the compounds of formula (I), (II), and/or (III), and/or their cocondensates and/or block cocondensates.

5. The method of claim 2, wherein the substrate is an inorganic material or an organic material having HO groups, having an MO group, and/or having O⁻ groups, or is a composite material, where M corresponds to an organic or inorganic cation.

6. The method of claim 2, wherein the substrate is a construction element, flame retardant, filler, carrier material, stabilizer, additive, pigment, added substance, and/or auxiliary.

7. A modified substrate, modified with at least one organofunctional silicon compound, and also, optionally, with at least one reaction product of an organofunctional carboxy compound.

8. The substrate of claim 7, which
has been modified with an organofunctional silicon compound which is a reaction product of a reaction of at least one organofunctionalized silane; and/or of at least one linear, branched, cyclic, and/or three-dimensionally crosslinked oligomeric, organofunctionalized siloxane in the presence of at least one organofunctional carboxy compound selected from the group consisting of a silicon-comprising precursor compound of an organic acid, an organic acid, and a silicon-free precursor compound of an organic acid.

9. The substrate of claim 7, wherein the organofunctional silicon compound is a reaction product from a reaction:
a.1) of at least one alkoxysilane of formula (III)
(B)_{b}SiR⁴ₐ(OR⁵)4_{-b-a} (III),
wherein
mutually independently b is 0, 1, 2, or 3 and a is 0, 1, 2, or 3, with the proviso that, in formula (III), b+a is smaller than or equal to (≦) 3,
B is mutually independently a monovalent organofunctional group,
R⁵ is mutually independently methyl, ethyl, n-propyl, or isopropyl,
R⁴ is mutually independently a substituted or unsubstituted carbon-containing group; and/or
a.2) of at least one linear, branched, cyclic, and/or three-dimensionally crosslinked oligomeric, organofunctionalized siloxane comprising at least one noncyclic and/or cyclic structural element represented in idealized form by formula (I) or (II), where crosslinked structural elements can lead to three-dimensionally crosslinked siloxane oligomers, 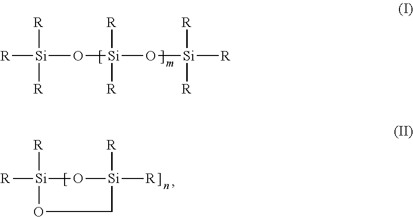
wherein R of the noncyclic, cyclic, and/or crosslinked structural elements are organic moieties and/or hydroxy groups, and a degree of oligomerization m for oligomers of formula (I) is in a range 0≦m<50, and, for oligomers of formula (II), n is in a range 2≦n≦50; or
a.3) of a mixture of at least two selected from the group consisting of the compounds of formula (I), (II), (III), their cocondensates, and block cocondensates;
in the presence of the substrate and
in the presence of an organofunctional carboxy compound selected from the group of:
b.1) a silicon-comprising precursor compound of an organic acid of formula £IVa) or (IVb),
(A)_{z}SiR²ₓ(OR¹)_{4-z-x} (IVa)
(R¹O)_{3-y-u}(R²)ᵤ(A)_{y}Si-A-Si(A)_{y}(R²)ᵤ(OR¹)_{3-y-u} (IVb).
wherein,
mutually independently, z is 0, 1, 2, or 3, x is 0, 1, 2, or 3, y is 0, 1, 2, or 3, and u is 0, 1, 2, or 3, with the proviso that in formula (IVa), z+x is smaller than or equal to (≦) 3 and in formula (IVb), y+u is independently smaller than or equal to (≦) 2,
A is mutually independently in formula (Iva) and/or (IVb) a monovalent organofunctional group, and A in the form of divalent moiety in formula (IVb) is a divalent organofunctional group,
R¹ is mutually independently a carbonyl-R³ group, where R³ corresponds to a moiety having from 1 to 45 carbon atoms,
R² is mutually independently a hydrocarbon group;
b.2) at least one organic acid selected from the group consisting of
iii.a) a carboxylic acid comprising from 4 to 45 carbon atoms,
iii.b) a saturated fatty acid, an unsaturated fatty acid, and/or
iii.c) a natural amino acid, and a synthetic amino acid; and
b.3) a silicon-free precursor compound of an organic acid.

10. The substrate of claim 7, having at least one selected from the group consisting of an HO group, an MO group, and an O⁻ group, and wherein the substrate is an organic or inorganic material, or a composite material.

11. A silane-terminated, polyurethane in the form of adhesive mass or sealant mass, wherein the polyurethane comprises the reaction product
of at least one aliphatic primary or secondary aminoalkoxysilane of formula (Via)
(R⁶)_{n′}NH_{(2-n′)}(CH₂)_{m′}Si(R⁷)_{v′}(OR⁸)_{(3-v′)} (VIa)
or of one aliphatic primary or secondary aminoalkoxysilane of the general formula (Vb),
(R⁶)_{n′}NH_{(2-n′)}CH₂CH(R⁷)CH₂Si(R⁷)_{v′}(OR⁸)_{(3-v′)} (VIb),
wherein n′ is 1,
R⁶ in the formulae (VIa) and (VIb) represents a linear or branched alkyl group having from 1 to 18 carbon atoms,
R⁷ is independently a methyl group,
R⁸ is independently a methyl, ethyl, or propyl group,
v′ is 0 or 1,
n′ is 0 or 1, and
m′ is 0, 1, 2, or 3,
with a polyurethane prepolymer,
wherein, subsequently, hydrolysis and/or condensation, of the alkoxy groups, takes place in the presence of a carboxy compound which is at least one selected from the group consisting of:
b.1) a silicon-comprising precursor compound of an organic acid of formula (IVa) or (IVb),
(A)_{z}SiR²ₓ(OR¹)_{4-z-x} (IVa)
(R¹O)_{3-y-u}(R²)ᵤ(A)_{y}Si-A-Si(A)_{y}(R²)ᵤ(OR¹)_{3-y-u} (IVb),
wherein,
mutually independently, z is 0, 1, 2, or 3, x is 0, 1, 2, or 3, y is 0, 1, 2, or 3, and u is 0, 1, 2 or 3 with the proviso that in formula (Iva), z+x is smaller than or equal to (≦) 3 and, in formula (IVb), y+u is independently smaller than or equal to (≦) 2,
A is mutually independently in formula (Iva) and/or (IVb) a monovalent organofunctional group, and A in the form of divalent moiety in formula (IVb) is a divalent organofunctional group,
R¹ is mutually independently a carbonyl-R³ group, where R³ corresponds to a moiety having from 1 to 45 carbon atoms,
R² is mutually independently a hydrocarbon group;
b.2) an organic acid selected from the group consisting of
iii.a) a carboxylic acid comprising from 4 to 45 carbon atoms,
iii.b) a saturated fatty acid, an unsaturated fatty acid,
iii.c) a natural amino acid, and a synthetic amino acid; and
b.3) a silicon-free precursor compound of an organic acid, and
wherein the at least one organofunctional carboxy compound, in the presence of at least one selected from the group consisting of an organofunctionalized silane, a linear, branched, cyclic, and/or three-dimensionally crosslinked oligomeric organofunctionalized siloxane, and a condensate thereof, acts as at least one selected from the group consisting of a silane hydrolysis catalyst and a silanol condensation catalyst.

12. A kit, comprising:
at least one organofunctional silane and/or at least one linear, branched, cyclic, and/or three-dimensionally crosslinked oligomeric, organofunctionalized siloxane, and/or mixtures and/or condensates of these, and
at least one organofunctional carboxy compound.

13. A process for producing a composition comprising at least one organofunctional silicon compound and comprising a silane hydrolysis catalyst and/or silanol condensation catalyst and, optionally, comprising a solvent and also, optionally, comprising water, the process comprising:
condensing and/or hydrolyzing the at least one organofunctional silane and/or one linear, branched, cyclic, and/or three-dimensionally crosslinked oligomeric, organofunctionalized siloxane, and/or their mixtures, and/or their condensates in the presence of moisture and in the presence of a carboxy compound which is at least one selected from the group consisting of:
b.1) a silicon-comprising precursor compound of an organic acid of formula (IVa) or (IVb),
(A)_{z}SiR²ₓ(OR¹)_{4-z-x} (IVa)
(R¹O)_{3-y-u}(R²)ᵤ(A)_{y}Si-A-Si(A)_{y}(R²)ᵤ(OR¹)_{3-y-u} (IVb),
wherein, mutually independently, z is 0, 1, 2, or 3, x is 0, 1, 2, or 3, y is 0, 1, 2, or 3, and u is 0, 1, 2, or 3, with the proviso that in formula (I), z+x is smaller than or equal to (≦) 3 and, in formula y+u is independently smaller than or equal to (≦) 2,
A is mutually independently in formula (IVa) and/or (IVb) a monovalent organofunctional group, and A in the form of divalent moiety in formula (IVb) is a divalent organofunctional group,
R¹ is mutually independently a carbonyl-R³ group, where R³ corresponds to a moiety having from 1 to 45 carbon atoms,
R² is mutually independently a hydrocarbon group;
b.2) at least one organic acid selected from the group consisting of
iii.a) a carboxylic acid comprising from 4 to 45 carbon atoms,
iii.b) a saturated and/or fatty acid, an unsaturated fatty acid,
iii.c) a natural amino acid, and a synthetic amino acid, and/or; and
b.3) a silicon-free precursor compound of an organic acid.

14. The process of claim 13, wherein a substrate is present.

15. A composition, obtained by the method of claim 13.

16. An adhesive, sealant mass, polymer composition, adhesive mass, colored material, or lacquer comprising the polyurethane of claim 11.

17. A method of treating, modifying, hydrophobicizing, or oleophobicizing a substrate, or providing an antifingerprint and/or antigraffiti property to a substrate, or promoting adhesion or binding, the method comprising:
combining at least one carboxy compound together with at least one organofunctionalized silane and/or with at least one linear, branched, cyclic, and/or three-dimensionally crosslinked oligomeric, organofunctionalized siloxane, and/or mixtures and/or condensates of these.

18. A silicon-comprising precursor compound of an organic acid of formula (IVa) and/or (IVb) the at least one organofunctional carboxy compound is selected from:
b.1) a silicon-comprising precursor compound of an organic acid of formula (IVa) or (IVb),
(A)_{z}SiR²ₓ(OR¹)_{4-z-x} (IVa)
(R¹O)_{3-y-u}(R²)ᵤ(A)_{y}Si-A-Si(A)_{y}(R²)ᵤ(OR¹)_{3-y-u} (IVb),
wherein, mutually independently, z is 0, 1, 2, or 3, x is 0, 1, 2, or 3, y is 0, 1, 2, or 3, and u is 0, 1, 2, or 3, with the proviso that in formula (IVa) z+x is smaller than or equal to (≦) 3 and in formula (IVb) y+u is independently smaller than or equal to (≦)₂,
A is mutually independently in formula (IVa) and/or (IVb) a monovalent organofunctional group, and A in the form of divalent moiety in formula (IVb) is a divalent organofunctional group,
R¹ is mutually independently a carbonyl-R³ group, where R³ corresponds to a moiety having from 1 to 45 carbon atoms, and
R² is mutually independently a hydrocarbon group.
